(19) United States
(12) Patent Application Publication
(10) Pub. No.: US 2008/0096118 A1
(43) Pub. Date: Apr. 24, 2008

(54) Polyester resin and manufacturing method thereof, electrostatic-image-developing toner, developing apparatus, cartridge, image-forming apparatus, and micro-reactor apparatus

(75) Inventors: Fumiaki Mera, Kanagawa (JP); Tetsuo Ohta, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/797,996

(22) Filed: May 9, 2007

(30) Foreign Application Priority Data
Oct. 19, 2006 (JP) 2006-284616

(51) Int. Cl. G03G 9/087; B01J 10/00; G03G 15/22

(52) U.S. Cl. 430/109.4; 399/148; 422/138; 430/135; 430/136

(57) ABSTRACT

A polyester resin has a molecular weight distribution (MWD) of approximately from 1.0 to 2.2, wherein molecular weight distribution (MWD) is a weight-averaged molecular weight (Mw)/a number-averaged molecular weight (Mn); and a luminosity (L*) of from approximately 97.0 to 100 when the polyester resin is molded in a diameter of 5 cm and a thickness of 2 mm.

### CROSS-REFERENCE TO RELATED APPLICATIONS

This application is based on and claims priority under 35 USC 119 from Japanese Patent Application No. 2006-284616 filed on Oct. 19, 2006.

### BACKGROUND

1. Technical Field

The present invention relates to a polyester resin, an electrostatic-image-developing toner including the polyester resin, a developing apparatus, a cartridge, and an image-forming apparatus. In addition, the present invention relates to a manufacturing method of the polyester resin, and a micro-reactor apparatus suitably used for the manufacturing method.

2. Related Art

Recently, because of a fast distribution of digital technologies, high definition in outputs of prints or copies used by a user of general homes, offices, a publishing business has been required. On the other hand, for the purpose of realizing a sustainable society, there have been highly required business activities, and low energy consumption and energy conservation for products which are a result of the activities.

Therefore, in an image forming method by an electrophotography method or an electrostatic printing method, it has been also required electric energy conservation in a fixing process consuming a lot of energy or activities for low environmental load. A counter plan corresponding to the former is to decrease fixing temperature of a toner. By decreasing the fixing temperature of the toner, waiting time required for a surface of a fixing member to have fixable temperature at the time of supplying power, that is, warm-up time can be shortened and an increase in lifetime of the fixing member can be obtained.

On the basis of such requirements, examinations for satisfying high definition, energy saving products, and energy saving manufacturing method by using raw material has been conducted. The characteristics of such examinations are highly dependent on a manufacturing method of a resin for toner which takes most parts of the toner or a characteristic thereof. As for the examples of the resin for toner, from the view point of achieving the energy saving manufacturing method, low temperature fixability, and high gloss level of the image, polyester resin is often used for the resin for toner so as to achieve the energy saving.

Particularly, the most parts of the polyester resin used for the resin for toner are formed of an amorphous polyester resin which includes an aromatic ring. As for the amorphous polyester resin, amorphous polyester resin is often used that is obtained by a condensation polymerization of aromatic polyvalent carboxylic acids such as terephthalic acid and isophthalic acid, aliphatic unsaturated carboxylic acids such as fumaric acid and maleic acid, and alicyclic diols such as diols having a bisphenol structure, aliphatic diol, cyclohexane dimethanol. As a catalyst for the condensation polymerization, lewis acid metal catalyst was used in the past and a lot of patent proposals relating thereto has been provided.

### SUMMARY

According to an aspect of the invention, there is provided a polyester resin having a molecular weight distribution (MWD) of approximately from 1.0 to 2.2, wherein the molecular weight is a weight-averaged molecular weight (Mw)/a number-averaged molecular weight (Mn); and a luminosity (L*) of from approximately 97.0 to 100 when the polyester resin is molded in a diameter of 5 cm and a thickness of 2 mm.

### BRIEF DESCRIPTION OF THE DRAWINGS

Exemplary embodiments of the present invention will be described in detail based on the following figures, wherein:

FIG. 1 is a plan view schematically illustrating an exemplary example of the micro-reactor apparatus suitably used in the invention;

FIG. 2 is an enlarged view conceptually illustrating a combined portion X of the flow channels L1 and L2;

FIG. 3 is a schematic view illustrating a exemplary example of a cross-sectional flow channel L3;

FIG. 4 is a cross sectional view schematically illustrating a base configuration of an exemplary embodiment of the image-forming apparatus of the invention;

FIG. 5 is a cross sectional view illustrating a base configuration of an exemplary embodiment;

FIG. 6 is a cross sectional view illustrating a base configuration of an exemplary embodiment; and

FIG. 7 is a cross sectional view illustrating a base configuration of an exemplary embodiment,

wherein 10 denotes MICRO-REACTOR APPARATUS; 20 denotes MICRO-REACTOR MAIN BODY; a1 and a2 denote MICRO-SYRINGE; A1 denotes FIRST FLUID; A2 denotes SECOND FLUID; L1 denotes FIRST FLOW CHANNEL; L2 denotes SECOND FLOW CHANNEL; L3 denotes COMBINED FLOW CHANNEL; L1′, L2′, L1″ and L2″ denote DISCHARGING FLOW CHANNEL; K1 and K2 denote FAUCET; P1 and P2 denote DIAPHRAGM PUMP; X denotes COMBINED PORTION; 200 denotes IMAGE-FORMING APPARATUS; 201 denotes IMAGE-FORMING APPARATUS; 207 denotes ELECTROPHOTOGRAPHIC PHOTOSENSITIVE MEMBER; 208 denotes CHARGING DEVICE; 209 denotes POWER SOURCE; 210 denotes EXPOSING DEVICE; 211 denotes DEVELOPING DEVICE; 212 denotes TRANSFER DEVICE; 212A denotes PRIMARY TRANSFER MEMBER; 212B denotes SECONDARY TRANSFER MEMBER; 213 denotes CLEANING DEVICE; 214 denotes ELECTRICITY REMOVER; 215 denotes FIXING DEVICE; 216 denotes MOUNTING RAIL; 217 denotes APERTURE FOR ELECTRICITY-REMOVING EXPOSURE; 218 denotes APERTURE FOR EXPOSURE; 220 denotes IMAGE-FORMING APPARATUS; 300 denotes CARTRIDGE; 400 denotes HOUSING; 401a, 401b, 401c and 401d denote ELECTROPHOTOGRAPHIC PHOTOSENSITIVE MEMBER; 402a, 402b, 402c and 402d denote CHARGING ROLL; 403 denotes LASER LIGHT SOURCE (EXPOSING DEVICE); 404a, 404b, 404c and 404d denote DEVELOPING DEVICE; 405a, 405b, 405c and 405d denote TONER CARTRIDGE; 406 denotes DRIVING ROLL; 407 denotes TENSION ROLL; 408 denotes BACKUP ROLL: 409 denotes INTERMEDIATE TRANSFER ROLL; 410a, 410b, 410c and 410d denote PRIMARY TRANSFER ROLL; 411 denotes TRAY (TRANSFERRING TRAY); 412 denotes TRANSPORTING ROLL; 413 denotes SECONDARY TRANSFER ROLL; 414 denotes FIXING ROLL; 415a, 415b, 415c and 415d denote CLEANING BLADE; 416 denotes CLEANING BLADE; and 500 denotes TRANSFERRED-ON MEDIUM (IMAGE OUTPUT MEDIUM).

### DETAILED DESCRIPTION

1. Polyester Resin

A polyester resin of the invention has a molecular weight distribution (MWD) represented by a weight-averaged molecular weight (Mw)/number-averaged molecular weight (Mn) in the range of 1.0 to 2.2 or less and a luminosity (L*) of a molded product formed from the polyester resin having a diameter of 5 cm and a thickness of 2 mm in the range of 97.0 to 100 or less.

<Molecular Weight Distribution (MWD)>

In the invention, the weight-averaged molecular weight Mw and the number-averaged molecular weight Mn are measured using gel permeation chromatography (GPC). For example, they are measured by a gel permeation chromatography (GPC: HLC-8120 GPC SC-8020 manufactured by Tosoh Corporation) under the conditions described later. At 40° C., a solvent (tetrahydrofuran) is spilled at a flow rate of 1.2 ml/min and 3 mg of a sample solution of tetrahydrofuran having a concentration of 0.2 g/20 ml is poured as a sample weight, thereby carrying out the measurement by the use of an IR detector. For measuring the molecular weight of the sample, there is selected a measurement condition in which the molecular weight of the sample is included in the range where the relation between a logarithmic value of the molecular weight from a calibration curve prepared by using several mono-disperse polystyrene standard samples and the count number becomes in a straight line.

In addition, reliability of the measurement result can be confirmed as that the NBS706 polystyrene standard sample has the following results under the above-mentioned measurement condition.

Weight-averaged molecular weight Mw=28.8×10⁴

Number-averaged molecular weight Mn=13.7×10⁴

TSK-GEL and GMH (manufactured by Toyo Soda Co., LTD.) which satisfy the above-mentioned conditions are used as a column of the GPC.

In the invention, the molecular weight distribution (MWD) is represented by Mw/Mn. When the value of MWD is small, it means that the molecular weight distribution is narrow and when the value of MWD is large, it means that the molecular weight distribution is wide.

In the polyester resin of the invention, MWD is 1.0 or more to 2.2 or less. It is preferable that MWD is in the range of 1.6 to 2.2 or less, more preferably 1.7 to 2.1 or less, and further preferably 1.8 to 2.0 or less.

When MWD is greater than 2.2, the resin becomes uneven at the time of heat melting and causes a slight defect to be generated in the heat processed molded product. When the polyester resin having MWD of 2.2 or more is used as a bonding resin for the electrostatic image toner, melting unevenness due to the wide range of molecular weight distribution is caused and thus gloss unevenness in a secondary color is generated.

<Luminosity (L*)>

The polyester resin of the invention has a luminosity (L*) value in the range of 97.0 to 100 when it is formed as a disc shaped molded product having the diameter of 5 cm and the thickness of 2 mm. The molded product used for measuring the luminosity is prepared by grinding thus obtained polyester resin to have a number average particle diameter of 1 mm or less, collecting 6.0 g of thus grounded dust, and applying approximately 20 t of a load using an extruder for 1 min. The extruder used herein is not particularly limited as long as it can apply the load.

In addition, the luminosity (L*) is obtained by measuring a central portion of the molded product having the diameter of 5 cm and the thickness of 2 mm with the use of a reflection densitometer. As for the reflection densitometer, X-Rite 404 manufactured by X-Rite Company may be used.

The luminosity (L*) of the polyester resin of the invention is in the range of 97.0 to 100 or less, preferably 97.5 to 100 or less, and more preferably 98 to 100 or less. When the luminosity (L*) is less than 97.0, the brightness of the polyester resin is deteriorated and thus its appearance is deteriorated. Furthermore, when the polyester resin having the luminosity (L*) of less than 97.0 is used as a binding resin for the electrostatic-image-developing toner, the image quality at the time of printing a low area coverage (low AC) image is deteriorated.

<Polycondensation Resin•Monomer>

In the invention, the polyester resin is obtained by a polycondensation reaction between a polycarboxylic acid and polyol (also referred to as polyvalent alcohol or polyalcohol), and may be obtained by an esterification reaction (dehydration reaction) between the polycarboxylic acid and the polyol or an ester exchange reaction between polycarboxylate polyalkyl ester and the polyol. As for the polycondensation reaction, any reaction may be used, but the polycondensation reaction accompanied with the dehydration reaction between the polycarboxylic acid and the polyol is preferred. In the invention, the polycarboxylic acid and the polyol which are polycondensation monomers for obtaining the polyester resin are referred to as polycondensation components or polyester monomers. In addition, the ‘polycondensation’ means a process for carrying out the esterification reaction (dehydration reaction) or ester exchange reaction, or a resultant which had been subjected to such a process. In the invention, when the polyester resin may be any one of a non-crystalline polyester resin and a crystalline polyester resin as long as it has the molecular weight distribution (MWD) and the luminosity (L*) in such the ranges, but the non-crystalline polyester resin is preferred.

Here, in the invention, the term ‘crystalline’ in ‘crystalline polyester resin’ means the resin having a definite endothermic peak which is not like an endothermic change on a step-shaped graph, in a differential scanning calorimetry (DSC). Specifically, it means the resin having a value of a half width of the endothermic peak within 15° C. when it is measured at an elevation temperature of 10° C./min. On the other hand, the resin having the value of the half width of the endothermic peak over 15° C. or the resin which does not have the definite endothermic peak means the non-crystalline (amorphous) resin.

Particularly, in the invention, it is preferable that the polyester resin is the non-crystalline polyester resin in which 50 mol % or more to 100 mol % or less of a structure derived from polycarboxylic acid satisfies the following formula (1) and/or (2) and 50 mol % or more to 100 mol % or less of a structure derived from polyalcohol satisfies the following formula (3). In addition, the ‘carboxylic acid’ includes its esterified compound and acid anhydride.

-A¹ₘB¹ₙA¹ₗ- (1)

### (A1: methylene group, B1: aromatic hydrocarbon group or substituted aromatic hydrocarbon group, 1≦m+1≦12, 1≦n≦3)

-A²ₚB²_{q}A²ᵣ- (2)

### (A2: methylene group, B2: alicyclic hydrocarbon group or substituted alicyclic hydrocarbon group, 0≦p≦6, 0≦r≦6, 1≦q≦3)

—XₕYⱼXₖ— (3)

(X: alkylene oxide group, Y: bisphenol unit group, 1≦h+k≦10, 1≦j≦3)

That is, the polyester resin of the invention is preferably the polyester resin obtained by the polycondensation reaction by using 50 mol % or more to 100 mol % or less of the dicarboxylic acid represented by the following formula (1′) or (2′) based on the total amount of the polycarboxylic acid and 50 mol % or more to 100 mol % or less of the diol based on the polyol represented by the following (3′).

R¹OOCA¹ₘB¹ₙA¹ₗCOOR^{1′} (1′)

(A¹: methylene group, B¹: aromatic hydrocarbon group or substituted aromatic hydrocarbon group, R¹, R^{1′}: hydrogen atom or monovalent hydrocarbon group, 1≦m+1≦12, 1≦n≦3)

R²OOCA²ₚB²_{q}A²ᵣCOOR^{2′} (2′)

(A²: methylene group, B²: alicyclic hydrocarbon group or substituted alicyclic hydrocarbon group, R², R^{2′}: hydrogen atom or monovalent hydrocarbon group, 0≦p≦6, 0≦r≦6, 1≦q≦3)

Here, the monovalent hydrocarbon group may indicate alkyl groups, alkenyl groups, alkynyl groups, aryl groups, hydrocarbon groups, or heterocyclic groups, and these groups may have any desired substituent.

### As for R1, R1′, R2, and R2′, hydrogen atoms or lower alkyl groups are preferred, hydrogen atoms, methyl groups, and ethyl groups are more preferred, and the hydrogen atom is most preferred.

HOXₕYⱼXₖOH (3′)

(X: alkylene oxide group, Y: bisphenol unit group, 1≦h+k≦10, 1≦j≦3)

Hereinafter, a unit derived from the polycarboxylic acid and a structure derived from the polyol will be described with reference to the dicarboxylic acid represented by the following formula (1′) or (2′), and the diol represented by the following formula (3′) which can be suitably used as the polycondensation monomers of the polyester resin of the invention as a matter of convenience of a description.

[Dicarboxylic Acid Represented by the Formula (1′)]

The dicarboxylic acid represented by the formula (1′) includes at least one of aromatic hydrocarbon groups B1, and its structure is not particularly limited. Examples of the aromatic hydrocarbon group B1 include benzene, naphthylene, acenaphthylene, fluorene, anthracene, phenantrene, tetracene, fluoranthene, pyrene, benzofluorene, benzophenantrene, chrysen, triphenylene, benzopyrene, perylene, anthracene, benzo naphthacene, benzochrysene, pentacene, pentaphene, coronene unit, and the like, and the examples are not limited thereto. In addition, a substituent may be further included in these structures.

The aromatic hydrocarbon group B1 may have a substituent. The substituent may be appropriately selected within a scope of achieving the object of the invention. Examples of the substituent include halogen atom, alkyl groups, and alkoxy groups.

A number of the aromatic hydrocarbon group B1 included in the dicarboxylic acid represented by the formula (1′) is in the range of 1 to 3 or less. When the number of B1 is in the range of 1 3 or less, the polyester resin thus prepared is non-crystalline, the synthesis thereof is easy and low in cost, preferable preparation efficiency can be obtained, and thus it is preferable. In addition, a melting point or a viscosity of the dicarboxylic acid represented by the formula (1′) is low, reactivity is excellent, and thus it is preferable.

When the dicarboxylic acid represented by the formula (1′) includes a plurality of aromatic hydrocarbon groups, the aromatic hydrocarbon groups may be bonded to each other or a structure of a unit having other saturated aliphatic hydrocarbon group therebetween is also possible. Examples of the former include biphenyl unit, examples of the later include bisphenol A unit, benzophenon, diphenylindene unit, and the examples are not limited thereto.

As for the aromatic hydrocarbon group B1, a structure having a main unit including carbon atoms in the range of C6 to C18 is preferred. For carbon atoms of the main unit, carbon atoms included in a functional group bonded to the main unit are not included. For example, benzene, naphthylene, acenaphthylene, fluorine, anthracene, phenanthrene, tetracene, fluoranthene, pyrene, benzofluorene, benzophenanthrene, chrysene, triphenylene, and bisphenol A unit. Among these, particularly preferred examples of unit include benzene, naphthylene, anthracene, and phenanthrene. The most preferably, the benzene and naphthylene structure are used.

When the carbon atoms of the main unit are 6 or more, the monomer is readily prepared, and thus it is preferable. When the carbon atoms of the main unit are 18 or less, size of the monomer molecule is appropriate, deterioration in the reactivity due to limitation in molecular movement is not occurred, and thus it is preferable.

The dicarboxylic acid represented by the formula (1′) may have at least one of methylene group A1. The methylene group may be either a straight-chained or a branched group, and can be exemplified by the methylene chain, branched methylene chain, substituted methylene chain, or the like. In the case of being a branched methylene chain, the branched moiety may have an unsaturated bond, or further branched or cyclic structure.

The number of methylene group A1 is preferably a sum of m+1 in the molecular in the range of 1 to 12 or less, more preferably m+1 in the range of 2 to 6 or less, and further preferably m=1. When m+1 is 0, that is, the dicarboxylic acid represented by the formula (1′) does not include the methylene group, the aromatic hydrocarbon and the carboxyl group at both terminals are directly bonded to each other. In this case, a reaction intermediate formed by a catalyst and the dicarboxylic acid represented by the formula (1′) becomes resonance stabilized and thus the reactivity may be deteriorated. Therefore, it is preferable that m+1 is 1 or more. When m+1 is larger than 12, the straight-chained portion of the dicarboxylic acid represented by the formula (1′) becomes excessively large so that the polymer thus prepared may have crystallinity or a glass transition temperature Tg thereof may be decreased. Therefore, it is preferable that m+1 is 12 or less.

The bonded parts of the methylene group A1 or carboxyl group, and the aromatic hydrocarbon group B1 are not particularly limited, and may be any one of opposition, m-position, and p-position.

Examples of the dicarboxylic acid represented by the formula (1′) include 1,4-phenylenedi acetate, 1,4-phenylenedi propionic acid, 1,3-phenylenedi acetate, 1,3-phenylenedi propionic acid, 1,2-phenylenedi acetate, and 1,2-phenylenedi propionic acid, but the examples are not limited thereto. Preferably, there may be used 1,4-phenylene dipropionic acid, 1,3-phenylene dipropionic acid, 1,4-phenylene diacetic acid, and 1,3-phenylene diacetic acid, and 1,4-phenylene diacetic acid, and 1,3-phenylene diacetic acid are more preferred for the toner.

Any functional groups may be added to the dicarboxylic acid represented by the formula (1′). The carboxylic acid group which is the functional group of polycondensation reactivity may be an anhydride, acid esterified compound, or acid chloride. However, since the intermediate between the acid esterified compound and the proton is readily stabilized and tends to suppress reactivity, the carboxylic acid, carboxylic acid anhydride, or carboxylic acid chloride is preferably used.

<Dicarboxylic Acid Represented by the Formula (2′)>

The dicarboxylic acid represented by the formula (2′) includes the alicyclic hydrocarbon group B2. Examples of the alicyclic hydrocarbon structure are not particularly limited and include a unit such as cyclopropane, cyclobutane, cyclopentane, cyclohexane, cycloheptane, cyclooctane, cyclononan, cyclodecane, cycloundecane, cyclododecane, cycloprophene, cyclobutene, cyclopentene, cyclohexene, cycloheptene, cyclooctene, norbornene, adamantane, diamantane, triamantane, tetramantane, aicyan, and twistane, and these examples are not limited thereto. For these substances, a substituent may be added. Considering that the stability, and large size or volume of the molecule, cyclobutane, cyclopentane, cyclohexane, norbornene, and adamantine are preferred.

### As for the substituent, the halogen atom, the alkyl group, or the alkoxy group may be used.

The number of alicyclic hydrocarbon groups included in the monomer is preferably 1 or more to 3 or less. When it is less than 1, amorphousness characteristics of the prepared polyester resin may be exhibited. Therefore, it is preferable that the number of the alicyclic hydrocarbon group is higher than 1. When the number of the alicyclic hydrocarbon group is higher than 3, increase in a melting point of the dicarboxylic acid represented by the formula (2′) or large size or volume of the molecule may be occurred and thus the reactivity may be deteriorated.

Therefore, the number of the alicyclic hydrocarbon is preferably 3 or less.

When a plurality of alicyclic hydrocarbon groups are included, any structures in which aromatic hydrocarbon groups are directly bonded to each other or other saturated aliphatic hydrocarbon groups are interposed therebetween are possible. Examples of the former include dicyclohexyl unit, and examples of the latter include hydrogenated bisphenol A unit. However, these examples are not limited thereto.

A preferred example of the alicyclic hydrocarbon group includes a material having carbon atoms in the range of C3 to C12 or less. These carbon atoms are not counted for carbon atoms included in the functional group bonded to the main unit. For example, a material having cyclopropane, cyclobutane, cyclopentane, cyclohexane, norbornene, or adamantane structure can be used. Among these, the cyclobutane, cyclopentane, cyclohexane, norbornene, or adamantane unit are particularly preferred.

The dicarboxylic acid represented by the formula (2′) may have the methylene group A2 in its structure. The methylene group may be either a straight-chained or a branched group, and can be exemplified by the methylene chain, branched methylene chain, substituted methylene chain, or the like. In the case of being a branched methylene chain, the branched moiety may have an unsaturated bond, or further branched or cyclic structure.

For the number of methylene group A2, it is preferable that p and r each are 6 or less. When p or r is larger than 6, or both are larger than 6, the straight-chained part of the dicarboxylic acid represented by the formula (2′) becomes excessively large. Thus, the polyester resin thus prepared may have crystallinity or a glass transition temperature Ta thereof may be decreased, so that the p and r each are preferably 6 or less.

The bonded parts of the methylene group A2 or the carboxyl group, and the alicyclic hydrocarbon group B2 are not particularly limited, and may be any one of o-position, m-position, and p-position.

Examples of the dicarboxylic acid represented by the formula (2′) include 1,1-cyclopropane dicarboxylic acid, 1,1-cyclobutane dicarboxylic acid, 1,2-cyclobutane dicarboxylic acid, 1,1-cyclopentene dicarboxylic acid, 1,4-cyclohexane dicarboxylic acid, 1,3-cyclohexane dicarboxylic acid, 1,2-cyclohexane dicarboxylic acid, 1,2-cyclohexene dicarboxylic acid, norbornen-2,3-dicarboxylic acid, and adamantane dicarboxylic acid, and the examples are not limited thereto. Among these, a preferably used one is a substance having a cyclobutane, a cyclohexane, and a cyclohexan unit, and particularly preferred on is 1,3-cyclohexane dicarboxylic acid and 1,4-cyclohexane dicarboxylic acid.

In addition, the dicarboxylic acid represented by the formula (2′) may include any kinds of functional group in its structure. The carboxylic acid group which is the polycondensation reactive functional group may be acid anhydride, an acidic esterified compound, and an acid chloride. However, since the intermediate between the acidic esterified compound and the proton becomes easily stabilized and tends to suppress the reactivity, the carboxylic acid or carboxylic acid anhydride, and the carboxylic acid chloride are preferably used.

In the invention, it is preferable that a compound (dicarboxylic acid) represented by the formula (1′) and/or (2′) is contained in the range of 50 mol % to 100 mol % or less, based on the total amount of the polycarboxylic acid component. The compound represented by the formula (1′) and/or (2′) may be used alone or in combination.

When the ratio of the compound represented by the formula (1) and/or (2′) is 50 mol % or more, the reactivity of the polycondensation at low temperature is sufficiently achieved. Therefore, the molecular is elongated so that the polyester resin having high polymerization degree is obtained, and thus it is preferable. Furthermore, less of the remained polycondensation component is existed, and thus it is preferable. Accordingly, without deteriorating fluidity of fine particles, for example, the polyester resin thus obtained becomes sticky at room temperature, desired viscoelasticity or glass transition temperature is obtained, and thus it is preferable. It is preferable that the compound represented by the formula (1′) and/or (2′) is contained in the range of 60 mol % to 100 mol % and it is further preferable that the compound represented by the formula (1′) and/or (2′) is contained in the range of 80 mol % to 100 mol % or less.

<Diol Represented by the Formula (3′)>

It is preferable that the polyester resin preferably used for the electrostatic-image-developing toner of the invention is obtained by the polycondensation reaction between the polycarboxylic acid and polyol, and 50 mol % or more to 100 mol % or less of the polylol is formed of a compound (diol) represented by the formula (3′).

HOXₕYⱼXₖOH (3′)

(X: alkylene oxide group, Y: bisphenol unit group, 1≦h+k≦10, 1≦j≦3)

The diol represented by the formula (3′) includes at least one bisphenol unit group Y. Examples of the bisphenol unit are not particularly limited as long as those are units having 2 phenol groups, and can be exemplified by bisphenol A, bisphenol C, bisphenol E, bisphenol F, bisphenol M, bisphenol P, bisphenol S, and bisphenol Z. The examples are not limited thereto. Preferably used units can be exemplified by the bisphenol A, bisphenol C, bisphenol E, bisphenol F, bisphenol M, bisphenol P, bisphenol S, and bisphenol Z, further preferably used units are the bisphenol A, bisphenol S, and bisphenol Z, and the particularly preferably used one is the bisphenol A.

For the number of the bisphenol units, it is preferable that j is in the range of 1 to 3 or less. When the diol represented by the formula (3′) does not have the bisphenol unit, the polyester resin thus prepared may have characteristics which belong to the crystalline polyester resin. Therefore, the number of the bisphenol unit is preferably 1 or more. On the other hand, when the number of the bisphenol is 3 or less, such the diol may be easily prepared, the practicality in the viewpoint of the efficiency-cost is suitably obtained, the molecular size is appropriate so that the reactivity is preferable in the viewpoint of the viscosity and melting point, and thus it is preferred.

In the invention, it is preferable that the diol represented by the formula (3′) has at least one alkylene oxide group. Examples of the alkylene oxide group include ethylene oxide group, propylene oxide group, butylene oxide group, or the like and the examples are not limited thereto. Preferably, the ethylene oxide and propylene oxide are used, and the ethylene oxide is particularly preferably used.

The number of alkylene oxide group h+k is preferably in the range of 1 to 10 in one molecular. When less than 1 of alkylene oxide group, that is, no alkylene oxide group is added, electrons are delocalized by the resonance stabilization between the hydroxyl group and the aromatic ring in the bisphenol unit and attackability of a nucleophile for the polycarboxylic acid by the diol represented by the formula (3′) weakens so that the molecular elongation or the increase in the polymerization degree may be suppressed. Therefore, it is preferable that h+k is 1 or more. When the number of the alkylene oxide group is larger than 10, the straight-chained portion of the diol represented by the formula (3′) becomes excessively large so that the polyester resin thus prepared may have crystallinity and the reactive functional group in the diol represented by the formula (3′) is decreased to that the reaction probability may decrease. Therefor, it is preferable that h+k is 10 or less.

It is preferable that h and k are same in the viewpoint of promoting an equivalent reaction. In addition, it is preferable that the number of the alkylene oxide group h+k is 6 or less, and it is more preferable that the number of the alkylene oxide group h and k each are 2 or 1. In case of being 2 or more of the alkylene oxide groups, 2 kinds or more of the alkylene oxide group may be included in one molecule.

Examples of the diol represented by the formula (3′) include bisphenol A ethylene oxide adduct (h+k is in the range of 1 to 10 or less), bisphenol A propylene oxide adduct (h+k is in the range of 1 to 10 or less), and ethylene oxide propylene oxide adduct (h+k is in the range of 2 to 10 or less), and can be exemplified by bisphenol Z ethylene oxide adduct (h+k is in the range of 1 to 10 or less), bisphenol Z propylene oxide adduct (h+k is in the range of 1 to 10 or less), bisphenol S ethylene oxide adduct (h+k is in the range of 1 to 10 or less), bisphenol S propylene oxide adduct (h+k is in the range of 1 to 10 or less), bisphenol F ethylene oxide adduct (h+k is in the range of 1 to 10 or less), bisphenol F propylene oxide adduct (h+k is in the range of 1 to 10 or less), bisphenol E ethylene oxide adduct (h+k is in the range of 1 to 10 or less), bisphenol E propylene oxide adduct (h+k is in the range of 1 to 10 or less), bisphenol C ethylene oxide adduct (h+k is in the range of 1 to 10 or less) bisphenol C propylene oxide adduct (h+k is in the range of 1 to 10 or less), bisphenol M ethylene oxide adduct (h+k is in the range of 1 to 10 or less), bisphenol M propylene oxide adduct (h+k is in the range of 1 to 10 or less), bisphenol P ethylene oxide adduct (h+k is in the range of 1 to 10 or less), and bisphenol P propylene oxide adduct (h+k is in the range of 1 to 10 or less). The examples are not limited thereto. Particularly preferably, it can be exemplified by ethylene oxide 1 mol adduct of bisphenol A (h and k each are 1), ethylene oxide 2 mol adduct of bisphenol A (h and k each are 2), propylene oxide 1 mol adduct of bisphenol A (h and k each are 1), ethylene oxide 1 mol propylene oxide 2 mol adduct of bisphenol A, ethylene oxide 2 mol adduct bisphenol Z (h and k each are 2), propylene oxide 1 mol adduct of bisphenol Z (h and k each are 1), ethylene oxide 1 mol propylene oxide 2 mol adduct of bisphenol Z, ethylene oxide 2 mol adduct of bisphenol S (h and k each are 2), propylene oxide 1 mol adduct of bisphenol S (h and k each are 1), and ethylene oxide 1 mol with propylene oxide 2 mol adduct of bisphenol S.

In the invention, it is preferable that the diol represented by the formula (3′) is contained in the polyol in the amount of 50 mol % or more to 100 mol % or less. When the content is within such range, the reactivity of the polycondensation at low temperature is sufficiently achieved and the molecular is elongated so that the polyester resin having high polymerization degree is obtained, and thus it is preferable. Furthermore, less of the remained polycondensation component is mixed, the polyester resin thus obtained is not sticky at room temperature, and the fluidity of the toner fine particles are not deteriorated when using the diol as the binding resin for the electrostatic-image-developing toner, and thus it is preferable. It is more preferable that the diol represented by the formula (3′) is contained in the range of 60 mol % to 100 mol % and it is further preferable that the diol represented by the formula (3′) is contained in the range of 80 mol % to 100 mol % or less.

<Catalyst>

In the invention, it is preferable that a catalyst is used when carrying out a polycondensation reaction and a bronsted acid including a sulfur element (hereinafter, the bronsted acid including the sulfur element is referred to as ‘sulfuric acid’) is used as the catalyst.

As for the sulfuric acid, an inorganic sulfuric acid and an organic sulfuric acid may be used. Examples of the inorganic sulfuric acid include sulfuric acid, sulfurous acid and salts thereof, and examples of the organic sulfuric acid include sulfuric acids such as alkyl sulfonic acid, aryl sulfonic acid, and salts thereof, and organic sulfuric acids such as alkyl sulfuric acid, aryl sulfuric acid, and salts thereof. As for the sulfuric acids, the organic sulfuric acid is preferred and the organic sulfuric acid having a surfactant effect is more preferred. The acid having the surfactant effect is a compound which has a chemical structure formed of a hydrophobic group and a hydrophilic group and an acid structure in which at least a part of the hydrophilic group is formed of proton, and serves as a emulsifier and a catalyst.

For example, as for the organic sulfuric acid having the surfactant effect, there may be used alkyl benzene sulfonic acid, alkyl sulfonic acid, alkyl disulfonic acid, alkyl phenol sulfonic acid, alkyl naphthalene sulfonic acid, alkyl tetralin sulfonic acid, alkyl allyl sulfonic acid, oil sulfonic acid, alkyl benzoimidazole sulfonic acid, fatty alcohol ether sulfonic acid, alkyl diphenyl sulfonic acid, long chain alkylsulfuric acid ester, fatty alcohol sulfuric acid ester, fatty alcohol ether sulfuric acid ester, higher fatty acid amide alkylol sulfuric acid ester, higher fatty acid amide alkylation sulfuric acid ester, sulfated fat, sulfosuccinic acid ester, resin acid alcohol sulfuric acid, and chloride compound thereof, and these may be used in combination if necessary. Among these, the sulfonic acid having aralkyl group, sulfuric acid ester having the alkyl group and aralkyl group, and the chloride compound thereof are preferred. A compound constituted by the alkyl group or alkyl group having carbon atoms of 7 or more to 20 or less is more preferable. Specifically, dodecyl benzene sulfonic acid, isopropylbenzene sulfonic acid, camphor sulfonic acid, paratoluene sulfonic acid, monobutylphenylphenol sulfuric acid, dibutylphenylphenol sulfuric acid, dodecyl sulfuric acid, and naphthenyl alcohol sulfuric acid can be used.

In the invention, it is preferable that the sulfuric acid may be used in the amount of 0.01 or more % by weight to 5 or less % by weight, based on a total weight of the polycondensation component (polyester monomer), more preferably in the amount of 0.03 or more % by weight to 3 or less % by weight, and further preferably in the amount of 0.05 or more % by weight to 2 or less % by weight.

In combination with the sulfuric acid catalyst or independently therefrom, another polycondensation catalyst which is generally used may be employed. Specifically, acids having the surfactant effect, metal catalysts, hydrolytic ferment type catalysts, and basic catalysts can be exemplified.

(Acids Having Surfactant Effect)

As for the acids having the surfactant effect, for example, various kinds of fatty acids, fatty alkyl phosphate ester, resin acids, and chlorides thereof may be used, and these may be used in combination if necessary.

(Metal Catalyst)

In the invention, when synthesizing the polyester resin, a metal catalyst may be used. As for the metal catalyst, the followings may be used but the examples are not limited thereto. For example, the catalyst containing organic tin compounds, organic titan compounds, organic halogenated tin compounds, and rare earth metals can be used.

As for the catalyst containing the rare earth metals, specifically, it is effective that the catalyst containing lanthanum (La), cerium (Ce), praseodym (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), and lutetium (Lu) as a scandium (Sc), yttrium (Y), and lanthanoid elements. It is effective that these have an sodium alkylbenzene sulfonate, alkylsulfate, and triflate structure, and the structure of the triflate can be exemplified by X(OSO₂CF₃)₃. Here, X is the rare earth element and is preferably scandium (Sc), yttrium (Y), ytterbium (Yb), and samarium (Sm).

As for the lanthanoid triflate, it is disclosed in ‘Organic Synthetic Chemistry Association Magazine’, the fifth Vol. 53, pages. 44 to 54, in detail.

When a metal catalyst is used as a catalyst, it is preferable that the metal component derived from the catalyst is 100 ppm or less in the polyester resin thus obtained, more preferably 75 ppm or less, and further preferably 50 ppm or less. Therefore, it is preferable that the metal catalyst is not used, or a little amount of the metal catalyst is used when using the metal catalyst. When the electrostatic-image-developing toner obtained by preparing the polyester resin using the metal catalyst over such the range is stored for a long period of time under high temperature and high humidity, the moisture in the atmosphere is adhered to the toner by the presence of the remained metals so that electric resistance of the toner particle is decreased and the charging amount is decreased. Thus, fog may be generated in the non-image portion.

The metal contents in the polyester resin can be measured by various analysis methods such as a fluorescent X-ray analysis or ICP (Inductively Coupled Plasma) emission analysis. Here, the metal contents derived from the catalyst means the total amount of titan, tin, and rare earth metal element.

In the invention, even when the polycondensation is conducted at a temperature lower than the conventional reaction temperature, a desired polyester resin can be obtained. The reaction temperature is preferably in the range of 70° C. to 750° C. or less, and more preferably in the range of 80° C. to 140° C. or less

When the reaction temperature is 70° C. or more, solubility of the polycondensed component and reactivity due to the decrease in catalyst activity are not decreased so that the molecular elongation is not suppressed, and thus it is preferable. In addition, when the reaction temperature is 150° C. or less, the resin can be prepared by consuming low energy, and thus it is preferable. Furthermore, coloration of the polyester resin and decomposition of the polyester resin thus prepared are not occurred, and thus it is preferable.

It is extremely important to produce polyester resins at low temperature of less than or equal to 150° C. without using a conventional high energy consuming preparing method with the total viewpoint of decreasing the preparing energy of the polyester resin and the preparing energy of the electrostatic-image-developing toner. In the past, the polycondensation reaction was performed at a high temperature of greater than 200° C. In order to perform the polycondensation reaction at a low temperature of 150° C. which are temperature dozens to hundreds ° C. lower than that, the sulfuric acid catalyst is preferably used. This is because, the metal catalysts such as conventional Sn-based-Ti-based show high catalyst activity at 200° C. and show excessively low activity at low temperature of less than or equal to 150° C. As for the sulfuric acid, the catalyst activity decreases with the elevated temperature at high temperature of more than 160° C., but the sulfuric acid has a reaction mechanism that the reaction is progressed by the nucleophile addition of the catalyst acid. Since the polymerization temperature is in the low temperature range of approximately 70° C. to 150° C. so that the catalyst activity is high, the polycondensation reaction can be appropriately performed at 150° C. or less.

In addition, in the electrostatic-image-developing toner produced by using the polyester resin, the polyester resin prepared by using the sulfuric acid catalyst is superior than the polyester resin prepared by using the metal catalyst in the aspect of the fog of the non image portion at the time of storing the toner under high humidity environment, and the aspect of mechanical strength. Since the sulfuric acid catalyst has a reaction mechanism in which the polymerizing is performed by the nucleophilic addition, impurities are hardly mixed. However, since the polyester resin prepared by using the metal catalyst such as the Sn-based or Ti-based has a reaction mechanism in which acids and alcohols are collected on the catalyst metal surface, the catalyst metals are readily introduced into the polyester resin. When a metal having conductivity is introduced into the polyester resin, leakage of electric charges is easily occurred. When such the polyester resin is used for the binding resin for the electrostatic-image-developing toner and particularly used in printing under the high temperature and high humidity, the leakage of the electric charges is easily occurred. Thus, there is a problem in that the charging amount is decreased so that background fog that the toner spatters on the non-image portion is easily generated. In addition, the introduced metals easily cause a slight structural defect in the polyester resin.

However, the introduction of such a metallic element can be prevented when using the sulfur acid catalyst so that the leak of electric charges is hardly occurred even under the high temperature and high humidity and the background fog is also hardly occurred, and thus it is preferable.

In this point, it is more preferable to use the sulfuric acid than the metal catalyst.

When the polyester resin of the invention is used as the binding resin for the electrostatic-image-developing toner, the glass transition temperature is preferably in the range of 30° C. to 90° C. from the viewpoint of stability and image formability. When the polyester resin having a glass transition temperature of over 30° C. is used as the binding resin for the electrostatic-image-developing toner, the fluidity of the toner fine particles is excellent at high temperature and cohesion of the polyester resin itself at high temperature range is also excellent so that hot offset is hardly generated, and thus it is preferable. In addition, when the glass transition temperature is 90° C. or less, sufficiently melting can be exhibited and excellent lowest fixing temperature can be obtained, and thus it is preferable.

The glass transition temperature is more preferably in the range of 40° C. to 80° C. or less, and further preferably in the range of 50° C. to 70° C. or less. The glass transition temperature can be controlled by the molecular weight of the polyester resin, the monomer structure of the polyester resin, or the addition of the cross linking agent.

Further, the glass transition temperature can be measured by a method defined as ASTM D3418-82 and measured by using a differential scanning calorimeter (DSC).

The weight-averaged molecular weight suitable for obtaining preferred toner properties of the polyester resin of the invention is preferably in the range of 5000 to 50000 or less, and more preferably 7000 to 35000 or less. When the weight-averaged molecular weight is 5000 or more, excellent fluidity of the fine particle can be exhibited and blocking of the toner having such the weight-averaged molecular weight is not generated, and thus it is preferable. In addition, the cohesion as the binding resin for the toner is excellent and the hot offset property is not deteriorated, and thus it is preferable. When the weight-averaged molecular weight is 50000 or less, excellent hot offset property and lowest fixing temperature can be obtained, and thus it is preferable. In addition, the time or the temperature required for the polycondensation is appropriate and the preparation efficiency is excellent, and thus it is preferable.

### The weight-averaged molecular weight is measured in the method as described above.

The polyester resin of the invention may be polycondensed together with the polycondensation component other than the component described above within a scope of not disturbing the characteristics.

As for the polycarboxylic acid, polyvalent carboxylic acids containing 2 or more of carboxyl groups in one molecule may be used. Among these, divalent carboxylic acid is a compound containing two carboxylic acids in one molecule and can be exemplified by oxalic acid, succinic acid, itaconic acid, glutaconic acid, glutaric acid, maleic acid, adipic acid, β-methyl adipic acid, suberic acid, azelaic acid, sebacic acid, nonane dicarboxylic acid, decane dicarboxylic acid, undecane dicarboxylic acid, dodecane dicarboxylic acid, fumaric acid, citraconic acid, diglycolic acid, maleic acid, citric acid, hexahydroterephthalic acid, malonic acid, pimelic acid, tartaric acid, mucic acid, phthalic acid, isophthalic acid, terephthalic acid, tetrachlorophthalic acid, chlorphthalim acid, nitro phthalic acid, biphenyl-p,p′-dicarboxylic acid, naphthylene-1,4-dicarboxylic acid, naphthylene1,5-dicarboxylic acid, naphthylene-2,6-dicarboxylic acid, anthracene dicarboxylic acid, n-dodecyl succinic acid, n-dodecenyl succinic acid, isodecyl succinic acid, isodecenyl succinic acid, n-octyl succinic acid, n-octenyl succinic acid, or the like. In addition, as for polyvalent carboxylic acids other than the divalent carboxylic acid, for example, trimerit acid, piromerit acid, naphthalene tri carboxylic acid, naphthalene tetracarboxylic acid, pyrene tricarboxylic acid, pyrene tetracarboxylic acid or the like may be used. As for the polycarboxylic acid used in combination thereto, dicarboxylic acids which are divalent carboxylic acids are preferred.

Furthermore, acid anhydride or acid anhydrochloride, and acidic esterified compound may be also used, but the examples are not limited thereto.

As for the polyol (polyvalent alcohol), the polyol containing two or more of a hydroxyl group in one molecule may be used. Among these, divalent polyol (diol) is a compound containing two hydroxyl groups in one molecule and can be exemplified by ethylene glycol, diethylene glycol, triethylene glycol, propylene glycol, butanediol, butenediol, neophentylglycol, pentaneglycol, hexaneglycol, cyclohexane glycol, cyclohexane dimethanol, otanediol, nonanediol, decanediol, dodecanediol, dipropylene glycol, polyethylene glycol, polypropylene glycol, polytetramethylene glycol, or the like. However, there may be also used bisphenol A which is bisphenols other than the bisphenols described above, or hydrogenated bisphenols. In addition, as for the polyol other than the divalent polyol, for example, glycerin, pentaerythritol, hexamethylol melamine, hexaethylol melamine, tetramethylol benzoguanamine, and tetraethylol benzoguanamine can be used.

Among these, it is preferable that the diol which is the divalent polyol is used in combination and the bisphenol A is preferably used as the polyol.

In the invention, as for the polycondensation process, there may be used a polymerization reaction between the polycarboxylic acid and the polyol which are previously described polycondensation component, and a prepolymer previously prepared. The prepolymer is not limited as long as it can be melted in or homogenously mixed with the monomer.

In addition, the polyester resin of the invention may have a homopolymer of the polycondensation component, a copolymer including two kinds or more of monomers containing aforementioned polymerization component or a compound thereof, graft polymer, or a partially branched or cross-linked structure.

The polyester resin of the invention described above can be suitably used to produce pigments, inks, cards, buttons on a cellular phone, adhesives, films, or toners.

2 Application to Micro-Reactor Produced by a Production Method of Polyester Resin

In the invention, as a production method of the polyester resin, a production method using a micro-reactor apparatus (simply referred to as a micro-reactor) is preferred. In the preparation of the polyester resin of the invention, the following production methods can be used. That is, the production method for the polyester resin includes an introducing process for introducing a liquid and a gas including a monomer of the polyester resin into a micro-flow channel, a flowing process for independently flowing the liquid and the gas, and a polycondensation process of the polycondensation of a polycondensation monomer on the liquid and the gas.

Unlike a batch-type reactor, the micro-reactor apparatus has a large surface area per unit volume, is excellent in heat efficiency and temperature control, and has regular temperature changes so that the reaction efficiency can be greatly improved. Thus, it can preciously control the reaction.

On the other hand, since synthesis of a polyester resin used in the past requires conditions of high temperature and low pressure, and long period of time, the micro-reactor can not be used for the past polyester resin. However, in synthesis of a polyester resin which enables the synthesis at low temperature by improving a monomer or changing a catalyst, such the micro-reactor can be used. Furthermore, dehydration reaction is promoted by polymerizing under a condition of flowing an inert gas such as nitrogen gas into a micro-flow channel of the micro-reactor and the reaction speed can be improved due to equilibrium reaction heading to forward reaction side. As a result, the reaction time can be significantly shortened.

Actually, in the preparation of the polyester resin by using the low-temperature-normal pressure method, the surface area per unit volume of the resin (surface area ratio of gas-liquid) is an important factor and it becomes apparent by the examinations of the inventors that the reactivity can be improved by increasing the surface area ratio. Here, the surface area ratio of gas-liquid means an area (m²/m³) contacting to the air per unit volume of the reaction composition including at least the polycondensation monomer (polycondensation component) and the catalyst.

For example, when a bulk polymerization is performed, in the examination for polycondensing bisphenol A ethylene oxide 1 mol adduct (2 mol adduct in terms of both terminal) and cyclohexane dicarboxylic acid at 120° C. for 2 hours, it is confirmed that the weight-averaged molecular weight leaner functionally increases by approximately 5900, 9500, and 12400 as the surface area ratio per unit volume increases by 0.5, 2.5, and 4.5, and the efficiency of the application of the micro-reactor which is large surface area per unit volume of the reactant is exhibited.

In addition, since the micro-reactor is excellent in temperature control and homogenous reactivity, and can decrease the reaction time, it is expected to provide the sharpener molecular weight distribution and decrease in coloration of the resin as compared to the polyester resin prepared by the batch-type reactor. When the toner is prepared by using such the polyester resin, the past objects of (1) irregular gloss in the secondary color due to the irregular melting caused by the molecular weight distribution, (2) decrease in the luminosity of the low area-coverage (low AC) due to the coloration of the resin caused by the metal catalyst and long period of reaction time, and (3) fog generated in the non-image portion under high temperature and high humidity caused by the metal catalyst can be resolved at one time.

### Hereinafter, the micro-reactor apparatus used for the preparation of the polyester resin and the production method using the same will be described.

3. Micro-Reactor Apparatus and Production Method of Polyester Resin

In the invention, the micro-reactor apparatus suitably used for the preparation of the polyester resin includes a micro-reactor main body, a micro-flow channel formed of a liquid flow channel and a gas flow channel, a circulating unit for supplying the liquid discharged from the micro-flow channel to the micro-flow channel again, and a heating unit for heating the micro-flow channel. Hereinafter, an example of a preferred exemplary embodiment of the invention will be described with reference to the drawing if necessary. The same parts or most parts are given by the same reference numerals, and the descriptions thereof will be omitted. For the specific parts, various aspects are possible.

The micro-reactor apparatus used for the preparation of the polyester resin of the invention is a reactor having a flow cannel of a micro-scale, has a micro-flow channel having a width of numbers μm to thousands of μm, and includes an introducing unit and a discharging unit at a starting point and ending point of the flow channel. Hereinafter, for the case of using the micro-reactor as the micro-flow channel, the production method of the polyester resin and the micro-reactor apparatus of the invention will be described.

(Polycondensation Processing Method)

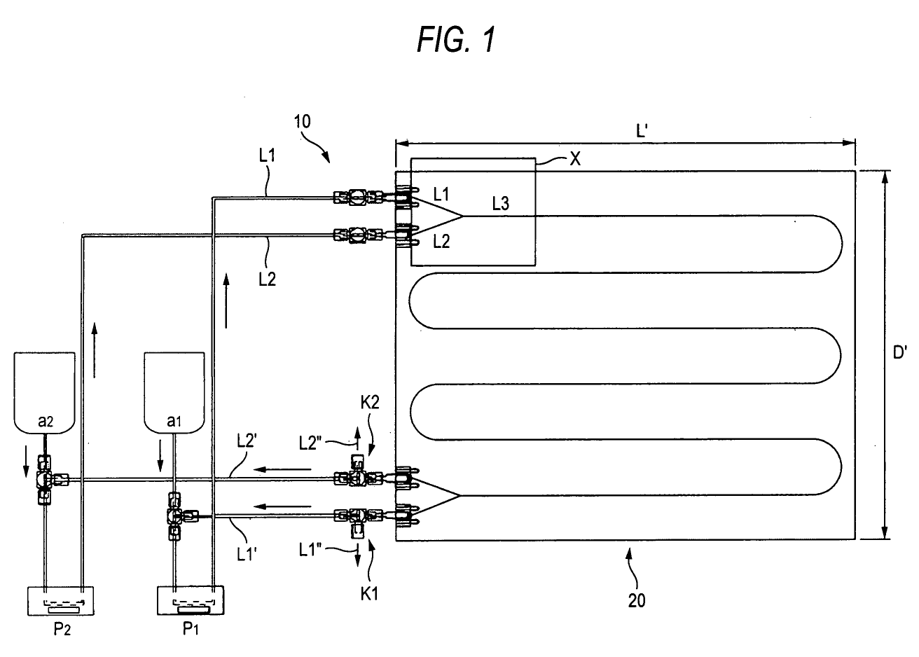

FIG. 1 is a plan view schematically illustrating one example of the micro-reactor apparatus suitably used in the invention. In FIG. 1, the micro-reactor apparatus 10 includes a flow channel L1 for passing a liquid (reaction liquid) prepared by melt blending a polyester resin monomer which is a first fluid and a catalyst, a flow channel L2 for passing a gas (inert gas) which does not react with the reaction liquid which is a second fluid, and a flow channel L3 for combining the flow channels L1 and L2 to be independently flown, in which each ends of the flow channels L1 and L2 are connected to each other. In addition, the first fluid (reaction liquid) includes at least the polyester resin monomer and the catalyst, and may include other components.

The first fluid in a micro-syringe a1 and the second fluid in a micro-syringe a2 are each extruded to the flow channels L1 and L2 by means of diaphragm pumps P1 and P2 respectively, supplied to a micro-reactor main body 20, and combined in the flow channel L3. In the invention, the micro reactor introduces the liquid (the first fluid) containing at least the polyester resin monomer and the catalyst into the flow channel L1 and the gas such as the inert gas (the second fluid) into the flow channel L2, and then supplies them together into one flow channel again.

The first fluid includes at least the polycarboxylic acid which is the polycondensation monomer and the polyol.

It is preferable that 50 mol % or more to 100 mol % or less of the polycarboxylic acid is dicarboxylic acid represented by the formulas (1′) and/or (21) and 50 mol % or more to 100 mol % or less of the polyol is the diol represented by the formula (3′).

In addition, it is preferable that the sulfuric acid is used as the catalyst as described above.

In addition, since the first fluid is supplied by using the micro-flow channel, it is preferable that viscosity of the first fluid to be supplied is in the range of 0.1 Pa·sec to 100 Pa·sec or less, and more preferably 0.5 Pa·sec to 80 Pa·sec or less. By giving the viscosity with such the range, the viscosity is appropriate so that it is suitable for supplying the liquid to the micro-flow channel, and thus it is preferable. In addition, in order to give the viscosity within such the range, a solvent is preferably added. A preferred example of the solvent is a solvent having a medium boiling point of 100° C. or higher which does not cause the reaction between the polyester resin and the polyester monomer and a solvent having 120° C. of a boiling point is more preferred. Specifically, it can be exemplified by xylene, methyl toluene, ethyl toluene, butyl toluene, methyl isobutyl ketone, methyl butyl ketone, diethylene glycol-diethyl ether, diethylene glycol-diethyl ether, diethylene glycol=dimethyl ether, 1,2-diethoxy methane, 1,2-diphenoxy ethane, and triethylene glycol dimethyl ether.

The second fluid is gas, and it is preferred to be the inert gas. Preferred examples of the inert gas include a nitrogen gas, an argon gas, a helium gas, or the like, and among these, the nitrogen gas is preferred. The inert gas is not limited to a slight amount of 100% pure gas, and may be a mixed gas and include a slight amount of impurities. The second fluid may be selected within the scope of not disturbing the polycondensation reaction of the first fluid.

The polyester monomer in the reaction liquid of the first fluid is subjected to the polycondensation reaction while independently flowing the liquid and supplying the liquid to the L3. Water or the like generated by the polycondensation reaction is diffused independently from the gas. In the invention, the micro-flow channel has a large area contacting to the liquid-gas surface so that the water generated by the polycondensation reaction is effectively diffused into the gas. As a result, the reaction speed is fast, and thus it is preferable.

In addition, the reaction liquid is classified into the discharging fluid channels L1′ and L2′ from the combined fluid channel L3, and discharged from the discharging fluid channel L1′, so that the gas is discharged from the discharging fluid channel L2′.

In FIG. 1, the reaction liquid discharged from the flow channel L1′ is re-supplied to the flow channel L1 by means of a diaphragm pump P1.

In addition, in FIG. 1, the inert gas discharged from the flow channel L2′ is re-supplied to the flow channel L2 by means of a diaphragm pump P2. The inert gas discharged from the flow channel L2′ contains moisture generated by the polycondensation reaction of the reaction liquid. It is preferable to decrease the moisture in the inert gas by drying or dehydrating the gas before being supplied to the flow channel L2 by the means of the diaphragm pump. In addition, in FIG. 1, the inert gas is circulated by the diaphragm pump P2. However, the invention is not limited thereto, the inert gas may not be circulated, and a new inert gas may be supplied from the flow channel L2.

In FIG. 1, a diaphragm pump is exemplified as a liquid supply pump, but the invention is not limited thereto. As the liquid supply pump, a pump capable of circulating is preferred.

As described above, by circulating the reaction liquid, the polycondensation reaction of the polyester resin can be performed to a desired molecular weight. In case of finishing the polycondensation reaction, the reaction liquid can be discharged from the flow channel L1″ by means of 3-way cock K1′ provided in the discharging flow channels.

In addition, a liquid supplying method, a mixing method, a heating method, and a circulation method are not particularly limited, and these may be used in combination by appropriately applying known means.

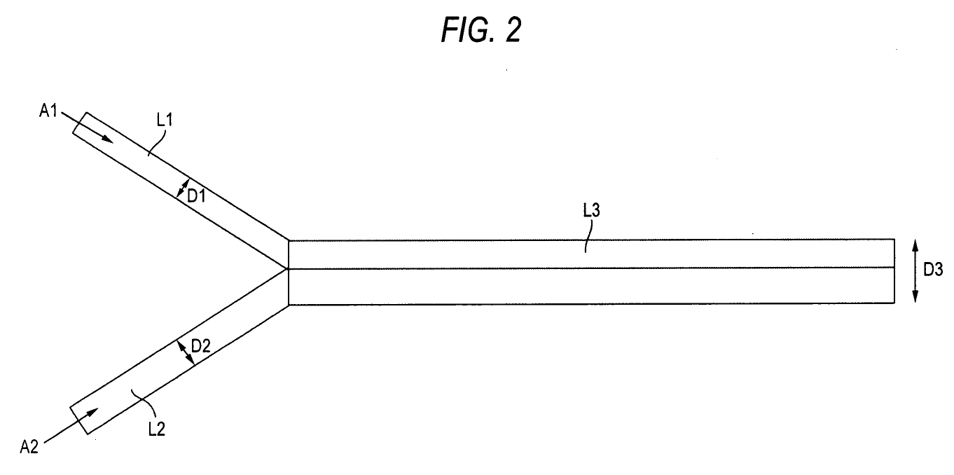

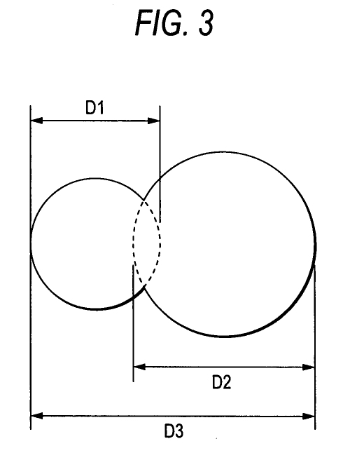

Next, a preferred exemplary embodiment of the flow channels L1 to L3 will be described with reference to FIGS. 2 and 3

FIG. 2 is an enlarged view conceptually illustrating a combined portion X of the flow channels L1 and L2.

In addition, FIG. 3 is a schematic drawing illustrating a preferred example of a cross-sectional flow channel L3.

The shapes of the flow channels L1 to L3 may be appropriately selected within a scope of stably flowing the first fluid A1 and the second fluid A2 independently in the flow channel L3. In the device, it is preferable that the cross section of the flow channel L3 is formed to have an eight-like shape so that the first fluid (reactant) is supplied to one side of the flow channel and the second fluid (inert gas) is supplied to the other side of the flow channel such to perform the reaction while forming the gas-liquid layers. However, in order to stably flow the gas and the liquid, it is more preferred to form the cross section of the micro-flow channel in a tumbling doll shape.

As described in FIGS. 2 and 3, when diameter of the fluid channel of the first flow channel L1 through which the first fluid (reaction liquid) passes is given by D1, diameter of the fluid channel of the second flow channel L2 through which the second fluid (inert gas) passes is given by D2, and width of the flow channel of the combined flow channel L3 having such a tumbling doll shape is given by D3, a ratio of D3 and (D1+D2) D3/(D1+D2) preferably satisfies the following formula (i).

0.55≦D3/(D1+D2)<1 (i)

In other words, D3/(D1+D2) is preferably less than 1, more preferably 0.6 or more to 0.95 or less, and further preferably 0.65 or more to 0.9 or less.

When D3/(D1+D2) is 0.5 or more, the layers are easily formed, excellent reactivity is obtained, and thus it is preferable. In addition, when D3/(D1+D2) is less than 1.0, the area where the first fluid (reaction liquid) and the second fluid (inert gas) contact to each other may be decreased in size or the contacting area may not be existed so that an effect for flowing the second fluid may not be readily obtained. Therefore, D3/(D1+D2) is within the such the range, excellent reactivity is obtained, and thus it is preferable.

In addition, ratio between D1 and D2 (D2/D1) preferably satisfies the following formula (ii).

1≦(D2/D1)≦10 (ii)

When D2/D1 is 1 or more, a preferable interface area between the reaction liquid and the inert gas is obtained and the dehydration efficiency is excellent so that sufficient reactivity is obtained, and thus it is preferable. When it is 10 or less, excellent productivity is obtained, thus it is preferable.

### It is more preferable that D2/D1 is in the range of 1.2 to 9.0 or less, and more preferably in the range of 1.4 to 8.0 or less.

It is preferable that the flow channel diameters D1, D2, and D3 satisfy the formulas (i) and (ii).

In addition, the flow channels L1, L2, and L3 preferably have the configurations described above and a configuration of a part exposed from the micro-reactor is not particularly limited. For example the flow channel parts in the diaphragm pumps P1 and P2 may not have a configuration satisfying the formulas (i) and (ii).

In addition, a liquid supply speed V₁ of the first fluid A1 is preferably in the range of 1 mL/s to 2000 mL/s or less, more preferably in the range of 5 mL/s to 1000 mL/s or less, and further preferably 10 mL/s to 1000 mL/s or less.

When the V₁ is 1 mL/min or more, layers are easily formed, excellent reaction efficiency is obtained, and thus it is preferable. When the V₁ is 2000 mL/min or less, the fluids can be stably supplied so that stable layers are obtained, excellent reaction efficiency is obtained, and thus it is preferable.

An introduction amount (liquid supply speed) of the second fluid A2 is preferably set to satisfy conditions satisfying the following formula (iii).

0.5 mL/s≦V₂≦10000 mL/s (iii)

When the flowing amount of the second fluid A2 is within such the range, layers are formed, excellent dehydration efficiency is obtained, a resin having an excellent molecular weight distribution is obtained, and thus it is preferable. In addition, the coloration of the resin is not occurred, and thus it is preferable.

As for a fine processing technology, there may be used a method of using LIGA technique using X-rays, a method of using a resist unit as a structure by photolithography method, a method of etching a resist aperture, a microelectric discharge processing method, a laser processing method, a mechanical micro-cut processing method using a microtoll made of a hard material such as a diamond, or the like. These techniques may be used alone or in combination, and there is no particular limitation. In addition, when assembling the micro-reactor of the present example, a bonding technique is used. The bonding technique can be classified by a solid-state bonding and liquid-state bonding. Examples of the solid-state bonding include an anodic bonding, a direct bonding, a diffusion bonding, or the like. Examples of the liquid-state bonding include a melt bonding, an adhesion, or the like, and there is no particular limitation.

The micro reactor of the invention can control the temperature. For example, a heater (heating device) is provided so that a temperature control device controls the temperature. As for the heater, a metal resistance or polysilicon is used and the heater may be provided in the device. In addition, in order to control the temperature, entire device or a part of the device may be stored in a case which is controlled in temperature.

For example, a heat source may be provided on an exterior of the micro-reactor such to control the temperature of the micro-reactor. For example, the micro-flow channel may be provided in the middle of the micro-reactor main body such to provide an exterior heat source. Since the micro-reactor has a large surface area with respect to the volume of the reaction liquid flowing in the flow, the temperature can be easily controlled from the exterior. Thus, it is preferable.

In addition, the temperature of the first fluid 1a supplied to the micro-reactor is preferably in the range of 70°c to 150° C. or less, more preferably in the range of 100° C. to 140° C. or less, and further preferably in the range of 110° C. to 130° C. or less. It is preferable that the temperature of the second fluid 2a is same as the first fluid 1a.

In addition, the temperature is regulated by the temperature which does not solidify the solution. It is preferable that the temperature control is performed by providing the temperature control device on the exterior of the reactor main body. As for the materials for making the micro-reactor apparatus, generally used one such as metals, ceramics, plastics, and glasses is possible, and it may be appropriately selected depending on a medium for supplying the liquid.

In the production method of the polyester resin of the invention, in order to volatilize by-products generated by the reaction, it is more preferable that an inert gas represented by nitrogen is introduced and the reaction is performed while volatilizing the by-products.

The flow channel diameter D1 of the first flow channel L1 is preferably in the range of 1 μm to 5000 μm or less, and more preferably in the range of 10 μm to 1000 μm or less. When the flow channel diameter D1 is 1 μm or more, the fluid can be stably supplied, reaction efficiency is improved, and thus it is preferable. When the D1 is 5000 μm or less, layers are readily formed, and thus it is preferable.

The length of the micro-flow channel in the micro-reactor main body as shown in FIG. 1 is preferably 30 cm or more, and more preferably 40 cm or more to 200 cm or less.

When the length of the micro-flow channel is within such the range, effect for increasing the gas-liquid interfacial area is obtained, reaction efficiency is improved, loss in flow speed is not occurred, and thus it is preferable.

Here, the length of the micro-flow channel means a total length of the first fluid in the micro-reactor main body.

Furthermore, the micro-reactor main body is a substrate portion having a length of L′ and a width of D′.

An aspect ratio (L′/D′) of the micro-reactor main body is preferably in the range of 1.0 to 3.0 or less, more preferably in the range of 1.1 to 2.9 or less, and further preferably in the range of 1.2 to 2.8 or less.

By giving the aspect ratio of the micro-reactor main body within such the range, a regular length of a flow channel can be obtained and a curved portion of the flow channel can be decreased so that loss in flow speed is not occurred and a disturbance in layers is not generated. Therefore, the micro-reactor having excellent reactivity can be obtained, and thus it is preferable.

In the micro-reactor, the discharging unit is parallel to the introducing unit, and angles formed by the introducing unit and the discharging unit with respect to the horizontal direction are preferably in the range of 0° to 45°, more preferably in the range of 0° to 30°, and further preferably in the range of 0° to 15°.

When the angle with respect to the horizontal direction of the flow channel is in the range of 0° to 45, the reaction liquid is not flown into the flow channel of the inert gas so that the gas-liquid layers formed in the flow channel is not disturbed, and thus it is preferable. As a result, a product having a sharp molecular weight distribution is obtained and the polyester resin having high molecular weight is obtained so that it is preferable. In addition, less remained monomer is existed, blockage in the flow channel is not occurred, and thus it is preferable.

In the production method of the polyester resin of the invention, it is preferable that the reactant is introduced from the introducing unit after the monomer and the catalyst are previously stirred for 5 minutes to 30 minutes in other vessel.

When the alcohol monomer, acid monomer, and catalyst are previously melt blended and then introduced in the device, the resultant is homogenously blended and a composition distribution of the polycarboxylic acid, polyol, and catalyst is not generated. Therefore, the sharp molecular weight distribution is obtained, generation of the remained monomer is prevented, and thus it is preferable.

In FIGS. 1 to 3, cross sections of the first flow channel and the second flow channel are circular, but the invention is not limited thereto. The cross sections of the flow channels may be selected from a circular, elliptical, rectangular, or square form. In the viewpoint of preventing the blockage of the flow channels, the cross sections preferably have rounded shapes, and circular shapes or elliptical shapes are preferred.

In FIGS. 1 to 3, the fluids a1 and a2 flow independently in the flow channel L3 having the tumbling doll shape, but a method of flowing the fluids may be appropriately selected within a scope of stably flowing the fluids. For example, the fluids may flow in the flow channel having a coaxial shape (the fluid a1 may flow in an inner layer and the fluid a2 may flow in an outer layer which winds the fluid a1, and vice versa).

4. A Method of Producing Toner

The polyester resin thus obtained may be used as the binding resin for the electrostatic-image-developing toner. The electrostatic-image-developing toner (simply referred to as the toner in the invention) may be produced by a melt mix-kneading method or a chemical production method.

In the melt mix-kneading method, a stirred product of the polyester resin thus obtained and the other raw materials for toner is melt kneaded in a state where it is melted by a known method. Since the kneading process performed by using a single screw or a double screw extruder contributes to improve the dispersibility, it is preferable.

In this case, the number of the kneading screw zones, temperature of the cylinder, and a kneading speed are required to be controlled by setting them as preferable values. Among control factors during the kneading process, the number of rotation of the extruder, the number of the kneading screws, and the temperature of the cylinder significantly influence the kneading process. In general, the rotation numbers are preferably in the range of 300 rμm to 1000, and an extruder having a plurality number of kneading screw zones such as double screws is more efficient as compared to the single screw.

The setting temperature of the cylinder is preferably determined depending on a softening temperature of the polyester resin which is the main component of the binding resin, and it is preferably −20° C. to +100° C. lower than the general softening temperature. When the cylinder temperature is setted in such the range, a sufficient kneading dispersion is obtained so that flocculation is not occurred, and thus it is preferable. In addition, a kneading share is brought so that sufficient dispersion can be obtained and a cooling process after the kneading can be easily performed, and thus it is preferable.

The melt kneaded product is grinded by a known method such as a mechanical grinding method using a ball mill, a sand mill, a hammer mill, or the like, or a gas-flow type grinding method. When the cooling processes can not be sufficiently performed by the generally used method, a cooling or freezing grinding method can be used.

For the purpose of controlling a particle distribution of the toner, it is preferable that the toner after grinding is classified. By glassifying the toner, particles having an inappropriate diameter are excluded so that the fixability of the toner and the image quality can be improved, and thus it is preferable.

On the other hand, in accordance with recent requests for high quality image, the chemical production method of the toner is widely employed to correspond to a technique for reducing the toner in diameter and producing the toner by consuming low energy. As for the chemical production method of the toner using the polyester resin of the invention, generally used methods can be used, but a flocculation and coalescence method is preferred. The flocculation and coalescence method is a known method of producing latex in which the binding resin including the polyester resin of the invention is dispersed and then flocculating (gathering) the latex with the other raw material for the other toner.

The method of dispersing the polyester resin in water is not particularly limited, and may be selected from known methods such as a forced emulsification method, a self-emulsification method, and a phase inversion emulsification method. Among these, considering that the energy required for emulsification, controllability of the particle diameter of the emulsified product thus obtained, and the stability, the self-emulsification method and the phase inversion emulsification method are preferably used. The self-emulsification method and the phase inversion emulsification method are described in ‘Application technology of ultrafine particle polymer’ (published by CMC Publishing CO., LTD). As a polar group used for the self-emulsification method, carboxyl group, sulfonic group, or the like may be used. In the invention, when the method is employed for the amorphous polyester resin for the toner, the carboxyl group is preferably used.

The toner of which the particle diameter is controlled by the flocculation (gathering) method can be prepared by using the bonding resin particle dispersed solution, that is, the latex. Specifically, the toner can be obtained by mixing the latex thus produced (binding resin particle dispersed solution) with the coloring agent particle dispersed solution and the releasing agent particle dispersed solution, adding the cohesion agent again, forming the flocculated particle of the toner diameter by causing a hetero-flocculation, heating the resultant to the temperature higher than the glass transition point of the binding resin particle or higher than the melting point so as to fuse-coalesce the flocculated particle, and then washing and drying the resultant. In this production method, the heating temperature condition may be selected, so that the shape of the toner can be controlled from amorphous forms to sphere forms.

After finishing the fusing coalescing process, any washing process, solid-liquid separation process, and drying process may be performed such to obtain a desired toner particle. However, considering a charging property, it is preferable that the washing process is performed by sufficiently substituting and washing with the use of ion-exchange water. In addition, the sold-liquid separation method is not particularly limited, but a suction filtering process or a pressurized filtering process is preferred in the viewpoint of the productivity. In addition, the drying process is not particularly limited, but lyophilization, flash jetdrying, flow drying, and vibration type flow drying are preferably used in the viewpoint of the productivity.

As for the cohesion agent, other than a surfactant, inorganic salts or metal salts having a valency of two or more can be appropriately used. Particularly, the metal salts are preferred in characteristics such as the cohesion control and the toner charging property. The metal salt compounds used for the cohesion are obtained by dissolving a general inorganic metal compound or the polymer thereof in the resin particle dispersed solution, but the metal element constituting the inorganic metal salts preferably includes an electric charge having a valency of two or more which belongs to 2A, 3A, 4A, 5A, 6A, 7A, BA, 1B, 2B, and 3B groups in a periodic table (long periodic table) and is preferably dissolved in ionic forms). Preferred examples of the inorganic metal salts include metal salts such as calcium chloride, calcium nitrate, barium chloride, magnesium chloride, zinc chloride, and aluminum chloride, aluminium sulfate; and inorganic metal salt polymers such as polyaluminum chloride, polyaluminum hydroxide, and calcium polysulfide. Among these, aluminium salts and the polymer thereof are preferred. In general, in order to obtain a sharpener particle distribution, the inorganic metal salts having a number of valecies of 3 or more is more preferable than that having the number of valecies of 2, and is further preferable than that having the number of valecies of 1. In addition, the inorganic metal salt polymer of polymerized type is more preferable than the polymer having the same valency.

In the invention, known additives may be added alone or in combination within a scope of not impairing the results of the invention. For example, a flame retardant, a flame retardancy auxiliary agent, a brightener, a waterproof agent, a water repellent, an inorganic filler (surface modifier), a release agent, an antioxidant, a plasticizer, a surfactant, a dispersion agent, a lubricant, a filler, a body pigment, a binder, and a electric charge controlling agent may be used. These may be blended in any process for preparing the electrostatic-image-developing toner Examples of the internal additives include the electric charge controlling agent such as quaternized ammonium salt compound or nigrosine-based compound, but the water insoluble material is preferred in the viewpoint of stability at the time of the preparation and decrease in wastewater pollution.

Examples of the releasing agent include low molecular weight polyolefins such as polyethylene, polypropylene, and polybutene; silicons having a softening point by heating; aliphatic amides such as oleic acid amide, erucic acid amide, ricinoleic acid, and stearic acid amide; plant-based waxes such as ester wax, carnauba wax, rice wax, candelilla wax, surmac wax, and jojoba oil; animal-based wax such as beeswax; mineral petroleum-based wax such as montan wax, ozokerite, ceresine wax, paraffin wax, microcrystalline wax, and Fischer-Tropsch wax; and modified products thereof.

These waxes can be easily prepared as particles having a particle diameter of 1 μm or less by a process including dispersing the wax in water together with an ionic surfactant and a polymer electrolyte such as a polymer acid or a polymer base, heating at a temperature above the melting point of the wax, and applying a strong shearing force to the resulting dispersion by means of a homogenizer or a pressure-ejection type dispersing machine.

The flame retardant and the flame retardancy auxiliary agent can be exemplified by bromine-based flame retardant, antimonous oxide, magnesium hydroxide, aluminium hydroxide, and ammonium polyphosphate, but the examples are not limited thereto.

As for the coloring components (coloring agent), various known pigments and dyes can be used. Specifically, examples of the coloring component include carbon blacks such as furnace black, channel black, acetylene black, and thermal black; inorganic pigments such as colcothar, Prussian blue, and titan oxide; azo pigments such as first yellow, disazo yellow, pyrazolone red, chelate red, brilliant carmine, and para brown; phthalocyanine pigments such as copper phthalocyanine and metal-free phthalocyanine; and polycyclic condensed pigments such as flavanthrone yellow, dibromoanthrone orange, perylene red, quinacridone red, and dioxazine violet. Various pigments including, chrome yellow, Hansa yellow, benzidine yellow, threne yellow, quinoline yellow, permanent orange GTR, pyrazolone orange, vulcan orange, Watchung red, permanent red, Dupont oil red, lithol red, rhodamine B lake, lake red C, rose bengal, aniline blue, ultramarine blue, calco oil blue, methylene blue chloride, phthalocyanine blue, phthalocyanine green, and Malachite green oxalate, C.I. pigment•red 48:1, C.I. pigment•red 122, C.I. pigment•red 57:1, C.I. pigment•yellow 12, C.I. pigment•yellow 97, C.I. pigment•yellow 17, C.I. pigment 15:1, and C.I. pigment•blue 15:3 may be used. These coloring agents may be used alone or in combination.

After drying in the same manner as a known toner production method, inorganic particles such as silica, alumina, titania, or calcium carbonate, or resin particles such as vinyl-based resin, polyester, or silicon may be externally added in a dried condition by shearing such particles, thereby using the particles as the fluent auxiliary agent or cleaning auxiliary agent.

As for the examples of the surfactant used for the processes of the invention, anionic surfactants, such as sulfate ester salts, sulfonate salts, phosphate ester and soaps; cationic surfactants, such as amine salts and quaternary ammonium salts; and nonionic surfactants such as polyethylene glycol, alkylphenol/ethylene oxide adducts and polyvalent alcohols may be used. The nonionic surfactant is used preferably in a combination with ananionic surfactant or a cationic surfactant. The dispersing means is not particularly limited, and examples of these means include a homogenizer with a rotating shearing mechanism, a ball mill with media, a sand mill and a Dyno mill.

The toner of the invention has an average particle diameter per volume (D₅₀) in the range of 3.0 μm to 20.0 μm. More preferably, the average particle diameter per volume is in the range of 3.0 μm to 9.0 μm. When the D₅₀ is 3.0 μm or more, the adhesion is preferable, developability is not decreased, and thus it is preferable. The D₅₀ is preferably 9.0 μm or less because sufficient property for obtaining a preferred resolution can be exhibited on this condition. The average particle diameter per volume (D₅₀) can be measured by using a laser diffraction-type particle size distribution measuring apparatus.

The toner of the invention preferably has a volume average particle size distribution index (GSDv) of 1.4 or less. When the toner is prepared by the chemical production method, it is further preferable that GSDv is 1.3 or less.

The GSDv has a cumulative distribution plotted as a function of the divided regions (channels) from the side of small particle size, where the particle diameter having a cumulative percentage of 16% is defined as volume D16v and the particle diameter having a cumulative percentage of 84% is defined as volume D₈₄ᵥ. Thus, by using the above-mentioned D₁₆ᵥ and D₈₄ᵥ, the volume average particle size distribution index (GSDv) is calculated by the following calculation.

Volume average particle size distribution GSDv=(D₈₄ᵥ/D₁₆ᵥ)^{0.5}

When the GSDv is 1.4 or less, the particle diameter becomes regular so that preferable fixability can be obtained, malfunction of the device caused by an erroneous fixing is not occurred, and thus it is preferable. In addition, contamination of the device caused by the scattering of the toner or the deterioration of the developer is not generated, and thus it is preferable. The average particle diameter per volume index (GSDv) can be measured by using the laser diffraction-type particle size distribution measuring apparatus.

When the toner of the invention is prepared by the chemical production method, the shape coefficient SF1 is preferably in the range of 100 to 140 in the viewpoint of image formability, more preferably in the range of 110 to 135 or less. The SF1 is calculated as follows:

$$SF 1 = \frac{{( ML )}^{2}}{A} \times \frac{π}{4} \times 100$$

Here, ML means an absolute longest length of the particle and A means the projection area of the particle. These are quantified by capturing mainly a microscope image or a scanning electron microscope image by the use of the luzex image analyzer and analyzing the image.

(Electrostatic Image Developer)

The electrostatic-image-developing toner is used as the electrostatic image developer. The developer is not particularly limited as long as it contains the electrostatic-image-developing toner and may have appropriate composition depending on the purpose. When the electrostatic-image-developing toner is used alone, it is prepared as the one component-based electrostatic-image-developing toner and when it is prepared in combination with a carrier, it is prepared as the two component-based electrostatic-image-developing toner.

The carrier to be used herein is not particularly limited, but there may be generally used magnetic particles such as iron powder, ferrite, iron oxide, and nickel; the resin-coated carriers which have the magnetic particles as the core particles and coat the core particles by resins such as styrene-based resin, vinyl-based resin, ethylene-based resin, rosin-based resin, polyester-based resin, and melamine-based resin, or waxes such as stearic acid so as to form a resin coated layer; and magnetic particulate dispersed carriers formed by dispersing the magnetic particulate in the binding resin. In the resin-coated carrier, the electric charging property of the toner or the resistance of the carrier can be controlled by the configuration of the resin-coated layer, and thus it is particularly preferable.

In the two component-based electrostatic image developer, the blending ratio of the toner and the carrier of the invention is preferably 2 parts by weight or more to 10 parts by weight or more of the toner, based on the 100 parts by weight of the carrier. The production method of the developer is not particularly limited, but it can be exemplified by a method using V blender.

(Developing Apparatus, Cartridge, and Image-Forming Apparatus)

The electrostatic-image-developing toner containing the polyester resin of the invention and the electrostatic image developer can be used in a developing apparatus, a cartridge, and an image-forming apparatus.

The developing apparatus of the invention includes an image carrier; a developer-supplying unit for supplying a developer including the electrostatic-image-developing toner of the invention on the image carrier; and a charging unit for charging the developer supplied by the developer-supplying unit.

The cartridge of the invention requires an image carrier and a developer unit for forming a toner image by developing a latent image formed on a surface of the image carrier by using the developer including the toner, and includes at least one of a charging unit for charging the surface of the image carrier and a cleaning unit for removing the developer remained on the surface of the image carrier. It is preferable that the cartridge of the invention is a process cartridge.

The image-forming apparatus of the invention includes the image carrier; the charging unit for charging a surface of the image carrier; the latent-image-forming unit for forming the latent image on the surface of the image carrier; the developer unit for forming the toner image by developing the latent image by using the developer including the toner of the invention; the transfer unit for transferring the toner image onto a recording medium; and a fixing unit for fixing the toner image on the recording medium.

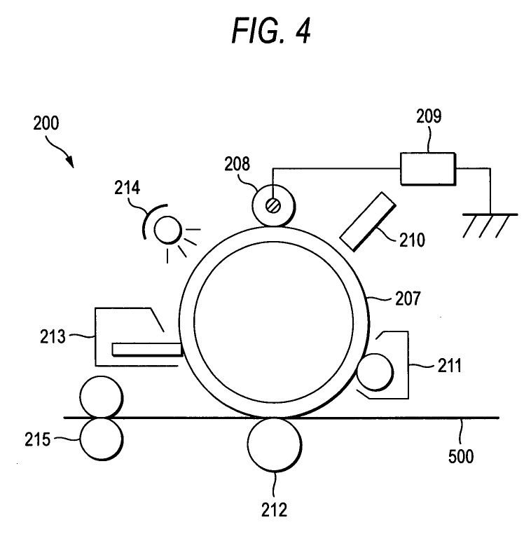

Hereinafter, the invention will be described with reference to FIGS. 4 to 7.

FIG. 4 is a cross sectional view schematically illustrating a base configuration of one exemplary embodiment of the image-forming apparatus of the invention. The image-forming apparatus 200 as shown in FIG. 4 includes an electrophotographic photosensitive member 207; a charging device 208 for charging the electrophotographic photosensitive member 207; a power supply connected to the charging device 208; a exposing device 210 for forming the latent image by exposing the electrophotographic photosensitive member 207 charged by the charging device 208; a developing apparatus 211 for forming the toner image by developing the latent image formed by the exposing device 210 by using the toner; a transfer device 212 for transferring the toner image formed by the developing apparatus 211 to a transferring medium (image output medium) 500; a cleaning device 213; a electricity remover 214; and a fixing device 215. In this case, electricity remover may not be provided.

Here, the charging device 208 is one of kinds (contact-charging type) that contact a charging roll serving as a conductive member to the surface of the electrophotographic photosensitive member 207 such to charge the surface of the photosensitive member 207.

In the invention, when the photosensitive member is charged by using the charging roll, voltage is applied on the charging roll. Such the applying voltage may be direct voltage or any one in which alternating voltage is applied on the direct voltage.

As for the exposing device 210, there may be used an optical system device which can expose the light source such as semiconductor laser, LED (Light emitting diode), liquid crystal shutter, or the like onto the surface of the electrophotographic photosensitive member in a desired shape.

As for the developing apparatus 211, a known developing apparatus which employs a normal or a reversal developer such as one component-based or two component-based may be used.

The electrostatic-image-developing toner of the invention may be used as the one component-based developer and the electrostatic-image-developing toner and the carrier of the invention may be used as the two component-based developer.

Examples of the transfer device 212 include a contact-type transfer charging equipment employing a belt, film, or rubber blade, scorotron transfer charging equipment employing the corona discharge, or corotron transfer charging equipment, other than the contact-charging member having a loller shape.

A preferred example of the transfer device 212 includes a device capable of supplying a current having a predetermined current density to an electrophotographic photosensitive member when transferring the toner image formed on the electrophotographic photosensitive member 207 to the transferring medium 500.

The cleaning device 213 is to remove the remained toner adhered to the surface of the electrophotographic photosensitive member after the transferring process and the electrophotographic photosensitive member having the surface thus cleaned up is re-provided to the image forming process. Examples of the cleaning device include a blush cleaning, roll cleaning, or the like, other than the cleaning blade, but the cleaning blade is preferably used. The cleaning blade may be made of urethane rubber, neoprene rubber, silicon rubber, and the like.

As shown in FIG. 4, the image-forming apparatus of the invention may include a light-scanning device as the electricity remover 214. Accordingly, when the electrophotographic photosensitive member is repeatedly used, a phenomenon in which the remained current on the electrophotographic photosensitive member is brought into the next cycle can be prevented, and thus the image quality can be improved.

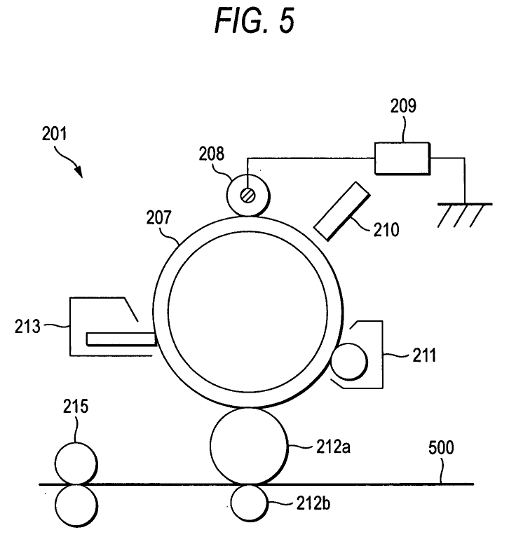

FIG. 5 is a cross sectional view illustrating a base configuration of one exemplary embodiment. The image-forming apparatus 201 shown in FIG. 5 includes an intermediate transfer type transfer device which transfers the toner image formed on the electrophotographic photosensitive member 207 to a primary transfer member 212a and then transfers the image to the transferring medium (image output medium) 500 provided between the primary transfer member 212a and a secondary transfer member 212b. When such the transferring process is performed, a current having a predetermined current density can be supplied to the electrophotographic photosensitive member from the primary transfer member 212a. In addition, it is not shown in FIG. 5, but the image-forming apparatus 201 may include the electricity remover as the image-forming apparatus 200 shown in FIG. 4. Other configuration of the image-forming apparatus 201 is same as the configuration of the image-forming apparatus 200.

In the image-forming apparatus 201, by supplying the current having the predetermined current density to the electrophotographic photosensitive member 207 from the primary transfer member 212a, when the toner image formed on the electrophotographic photosensitive member 207 is transferred to the primary transfer member 212a, variations in the transfer current due to kinds-materials of the transferring medium 500 can be prevented. Therefore, the amount of the electric charges supplied to the electrophotographic photosensitive member 207 can be precisely controlled. As a result, decrease in the high image quality and the environmental load can be further achieved.

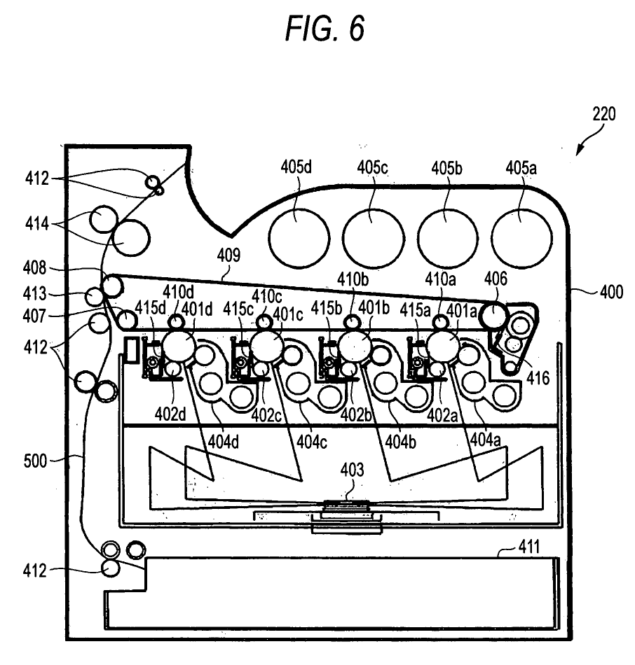

FIG. 6 is a cross sectional view illustrating a base configuration of one exemplary embodiment. An image-forming apparatus 220 shown in FIG. 6 is an intermediate transfer type image-forming apparatus. In a housing 400, four of electrophotographic photosensitive members 401a to 401d (for example, an image having colors can be obtained by an electrophotographic photosensitive member 401a of yellow, an electrophotographic photosensitive member 401b of magenta, an electrophotographic photosensitive member 401c of cyan, and an electrophotographic photosensitive member 401d of black) are formed in parallel to each other along an intermediate transfer belt 409. Here, the electrophotographic photosensitive members 401a to 401d stored in the image-forming apparatus 220 each are electrophotographic photosensitive members.

Each one of the electrophotographic photosensitive members 401a to 401d can rotate in a predetermined direction (the surface of the paper rotates counterclockwise), and charging rolls 402a to 402d, developing apparatuses 404a to 404d, primary transfer rolls 410a to 410d, and cleaning blades 415a to 415d are disposed long the rotation direction. Each one of the developing apparatuses 404a to 404d can be supplied with four colors of toner such as black, yellow, magenta, and cyan stored in toner cartridges 405a to 405d. The primary transfer rolls 410a to 410d are abut on the electrophotographic photosensitive members 401a to 401d through the intermediate transfer belt 409.

In a predetermined position in the housing 400, a laser light source (exposing device) 403 is formed so that the laser light emitted from the laser light source 403 can be scanned to the surface of the electrophotographic photosensitive members 401a to 401d after charging. Accordingly, in the rotation process of the electrophotographic photosensitive members 401a to 401d, each processes of charging, exposing, developing, primary transferring, and cleaning can be subsequentially performed and the toner images of the respective colors are overlapped on the intermediate transfer belt 409 and then transferred.

The intermediate transfer belt 409 is supported to have a predetermined tension by a driving roll 406, a backup roll 408, and tension roll 407 and can be rotated by the rotations of such rolls without being bent. In addition, the secondary transfer roll 413 is disposed to abut on the backup roll 408 through the intermediate transfer belt 409. The intermediate transfer belt 409 passing between the backup roll 408 and the secondary transfer roll 413 can have a clean surface by the cleaning blade 416 disposed around the driving roll 406, and then repeatedly provided to the next image forming process.

In a predetermined position in the housing 400, a tray (transferring medium tray) 411 is formed. The transferring medium 500 such as a paper in the tray 411 is transported between the intermediate transfer belt 409 and the secondary transfer roll 413 by a transport roll 412, and transported between two fixing rolls 414 abutting to each other in this order, and then the paper is discharged to the outside of the housing 400.

In addition, in the aforementioned description, the intermediate transfer belt 409 has been used as the intermediate transfer medium, but the intermediate transfer medium may have a belt shape or a drum shape as the intermediate transfer belt 409. As for the resin material used as a base material for the intermediate transfer medium in case of forming the belt shaped medium, a known resin may be used. For example, resin materials such as polycarbonate resin (PC), polyvinylidene fluoride (PVDF), polyalkylene terephthalate (PAT), blended material of ethylene tetrafluoroethylene copolymer (ETFE)/PC, ETFE/PAT, and PC/PAT, polyester, polyester ether ketone, and polyamide; and resin materials formed by using those materials as the main materials. In addition, the resin materials and the elastic materials may be blended.

As for the elastic materials, a material formed by blending one or two kinds or more of polyurethane, polyisoprene chloride, NBR, chloroprene rubber, EPDM, hydrogenated polybutadiene, butyl rubber, and silicon rubber may be used. One kind or two kinds or more of a conductive agent giving electron conductivity and a conductive agent having ion-conductivity may be blended and added to the resin materials and the elastic materials used for the base materials, if necessary. Among these, the polyimide resin to which the conductive agent is dispersed is preferred because of its excellent mechanical strength. As the conductive agent, conductive polymers such as carbon black, metal oxides, Or polyaniline may be used.

When the intermediate transfer medium is formed to have the belt shape as the intermediate transfer belt 409, the thickness of the belt is generally in the range of 50 μm to 500 μm, and more preferably in the range of 60 μm to 150 μm, but it may be selected depending on a hardness of the materials.

For example, as disclosed in Japanese Unexamined Patent Application Publication No. 63-311263, the belt formed from the polyimide resin to which the conductive agent is dispersed can be produced by dispersing 5 mol % or more to 20 mol % or less of carbon black serving as the conductive agent in the polyamide acid solution serving as the polyimide precursor, flow casting the dispersion liquid on the metal drum to dry the liquid, and then kneading the film peeled off from the drum under high temperature to form a polyimide film, and cutting the film with a desired size to serve as an undressed belt.

The film can be generally obtained by injecting a film forming solution of the polyamide acid solution to which the conductive agent is dispersed into a cylindrical mold, rotating the cylindrical mold by the rotation number of 500 rμm or more to 2000 rμm or less while heating the mold to approximately 100° C. or higher to 200° C. or lower, and forming the resultant into a film shape by a mono axial molding method, and then the film thus obtained is removed from the mold in a partially cured state, and then cured again by performing polyimide reaction (ring-closing reaction of the polyamide acid) at high temperature of 300° C. or higher by coating a iron core. In addition, the film forming solution may be flow casted with a uniform thickness on the metal sheet, most parts of the solvent is removed by heating to the temperature of 100° C. or higher to 200° C. or lower, and then the temperature is elevated to the high temperature of 300° C. or higher step by step, thereby obtaining the polyimide film. The intermediate transfer medium may have a surface layer.

When the intermediate transfer medium is formed to have the drum shape, cylindrical base materials formed from aluminium, stainless steel (SUS), or copper are preferably used. On the cylindrical base materials, the elastic layer is coated and the surface layer is formed thereon if necessary.

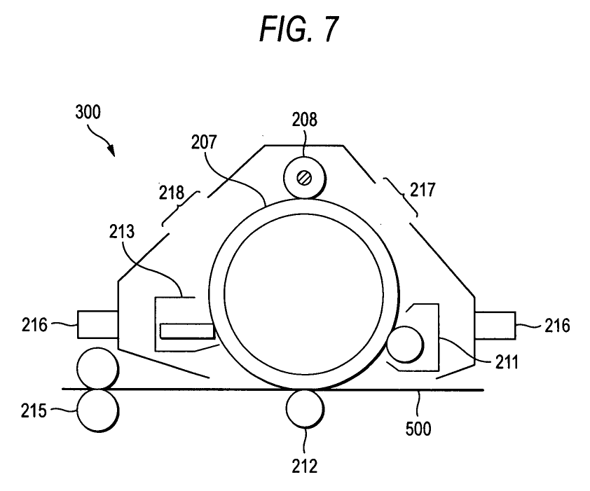

FIG. 7 is a cross sectional view illustrating a base configuration of one exemplary embodiment. A cartridge 300 uses the mounting rail 216 to combine the electrophotographic photosensitive member 207, the charging device 208 having the charging roll, the cleaning device (cleaning unit) 213, the aperture 218 for exposing light, and the aperture 217 for the electricity-removing exposure, along with the developing apparatus 211 of the invention, and unifies them.

The cartridge 300 is detachably formed in the image-forming apparatus main body formed of the transfer device 212, the fixing device 215, and other components not shown, and constitutes the image-forming apparatus together with the image-forming apparatus main both.

### EXAMPLES

(Example of Resin and Resin Dispersion Liquid)

Hereinafter, the invention will be described in detail with reference to Examples. In addition, the invention is not limited to the following examples and details of the invention may be modified in various aspects.

<Preparation of Micro-Reactors 1 to 7>

The micro-reactors used in the present examinations are shown in FIGS. 1 to 3. A cross section of the micro-channel is shown in FIG. 3.

[Production of Channel Organizer]

Firstly, on a glass substrate having 260 mm in depth direction×320 mm of width (in liquid supplying direction)×30 mm of thickness (L′/D′=1.23), the channel shown in FIGS. 1 to 3 is formed by a microfabrication technology including a register process. Examples of the microfabrication technology for forming a flow channel include a method of employing an LIGA technology using X-ray; a method of using a register unit as a structure body by a photolithography method; a method of etching-treating an opening of the register; an electrical discharging process; a laser process; a mechanical micro cutting process using micro tools made of a solid material such as a diamond; and the like. These technologies may be used alone or in combinations thereof. However, according to the present example, production is carried out by using the mechanical micro cutting process using micro tools.

At this time, the flow channel is produced to have diameters D1, D2, and D3 as D1=300 μm, D2=300 μm, D2/D1=1.0, and D3=500 μm; and have the total length of 210 cm.

In the micro-reactor of the present Example, a heater is installed and set as the temperature thereof to be controlled by an external temperature control device. A metal resistor or poly silicone is used as the heater. The heater is installed in the device to control the temperature.

In addition, in the same manner as mentioned above, values of the flow channel diameters D1, D2, and D3 are changed to the values listed in Table 1 and the micro-reactors 2 to 6 are produced to have the total flow channel length of 210 cm.

Further, the micro-reactor 7 of which total flow channel length is changed to 300 cm is produced.

TABLE 1

| | | Micro-reactor | | | | | | |
|---|---|---|---|---|---|---|---|---|
| | | 1 | 2 | 3 | 4 | 5 | 6 | 7 |
| Flow | D1 (μm) | 300 | 80 | 200 | 300 | 300 | 200 | 300 |
| Channel | D2 (μm) | 300 | 800 | 600 | 300 | 300 | 600 | 300 |
| Diameter | D3 (μm) | 500 | 840 | 700 | 500 | 500 | 700 | 500 |

| | | | | | | | |
|---|---|---|---|---|---|---|---|
| D2/D1 | 1 | 10 | 3 | 1 | 1 | 3 | 1 |
| D3/(D1 + D2) | 0.83 | 0.95 | 0.88 | 0.83 | 0.83 | 0.88 | 0.83 |
| L′ (mm) | 320 | 320 | 320 | 320 | 600 | 480 | 320 |
| D′ (mm) | 260 | 260 | 260 | 320 | 205 | 240 | 260 |
| L′/D′ | 1.23 | 1.23 | 1.23 | 1.00 | 2.93 | 2.00 | 1.23 |
| Flow Channel | 210 | 210 | 210 | 210 | 210 | 210 | 300 |
| Length (cm) | | | | | | | |

<Preparation of Resin P1>

| | |
|---|---|
| Ethylene oxide 1 mol adduct of bisphenol A | 23.85 parts by weight |
| (2 mol adduct to both terminals) | |
| Bisphenoxy ethanol fluorene (2 mol adduct to | 8.14 parts by weight |
| both terminals) | |
| 1,4-cyclohexane dicarboxylic acid | 16.00 parts by weight |
| Dodecylbenzene sulfonic acid | 0.03 parts by weight |
| Xylene | 20 parts by weight |

Above materials are mixed and introduced to a reactor equipped with a stirrer. The mixture is stirred for 10 minutes in a closed system to reach 120° C. of the resin temperature, thereby obtaining a monomer mixed liquid (1) in which the materials are uniformly mixed.

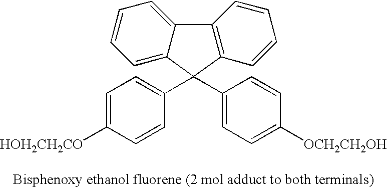

A flow rate of the monomer mixed liquid (1) is set to have the same rate of nitrogen gas, and the liquid is poured into an introductory part of the micro-reactor 1 produced as above at a uniform inflow rate of 40 mL/min. A temperature control is carried out to constantly have the temperature of materials of 130° C. Nitrogen continuously is spilled in the flow channel of the micro-reactor for 2 hours to maintain a volume flow rate of nitrogen to have the same flow rate of the monomer mixed liquid (1). After that, reactants are recovered to obtain a uniformly transparent non-crystalline polyester resin. The reactants are removed from a desiccator under reduced pressure and the solvent is continuously removed for 10 hours.

Here, small amount of a resin sample is collected to measure the following properties.

| | |
|---|---|
| Number-averaged molecular weight Mn | 5980 |
| Weight-averaged molecular weight Mw | 12660 |
| MWD | 2.12 |
| Glass transition temperature (onset) | 60° C. |
| L* of resin powder pellet | 97.22 |

[Measurement of Mw and Mn]

For measuring the above molecular weight, the weight-averaged molecular weight Mw and the number-averaged molecular weight Mn are measured by a gel permeation chromatography (GPC: HLC-8120 GPC SC-8020 manufactured by Tosoh Corporation) under the conditions described later. At 40° C., a solvent (tetrahydrofuran) is spilled at a flow rate of 1.2 ml/min and 3 mg of a sample solution of tetrahydrofuran having a concentration of 0.2 g/20 ml is poured as a sample weight, thereby carrying out the measurement by the use of an IR detector. For measuring the molecular weight of the sample, there is selected a measurement condition in which the molecular weight of the sample is included in the range where the relation between a logarithmic value of the molecular weight from a calibration curve prepared by using several mono-disperse polystyrene standard samples and the count number becomes in a straight line.

In addition, reliability of the measurement result can be confirmed as that the NBS706 polystyrene standard sample has the following results under the above-mentioned measurement condition.

Weight-averaged molecular weight Mw=28.8×10⁴

Number-averaged molecular weight Mn=13.7×10⁴

TSK-GEL and GMH (manufactured by Toyo Soda Co., LTD.) which satisfy the above-mentioned conditions are used as a column of the GPC.

[measurement of Glass Transition Point (Tg)]

For measuring a glass transition point Tg of the polyester resin, a differential scanning calorimeter (DSC 50 manufactured by Shimadzu Corporation) is used. The glass transition point is measured in accordance with ASTM D3418-82.

[Measurement of Luminosity (L*)]

For measuring a value of luminosity (L*) of the resin, a pellet of the resin is prepared by using the method described later and subjected to a measurement by using X-Rite404 (manufactured by X-Rite) to measure the L*.

—Method of Preparing Pellet—

The resin thus obtained is grinded by a sample mill until the average particle size of the resin particle becomes approximately 1 mm or below. 6.0 g of the grinded product is collected and 20 t of load is supplied to a pressure molding machine for 1 min to obtain a disk-shaped pellet having 5 cm of diameter×3 mm of thickness

—Method of Measuring Luminosity (L*)—

A central portion of the pellet having 5 cm of diameter×3 mm of thickness thus obtained is subjected to a measurement by using a reflection densitometer (X-Rite404 manufactured by X-Rite Co., Ltd.) and luminosity (L*) is obtained.

A detection amount of a metal derived from a catalyst contained in the resin thus obtained is measured by using a fluorescent X-ray and is a detection limit or below. In addition, the detection amount is set to be 0 ppm when it is the detection limit or below.

<Preparation of Resin P2>

The monomer mixed liquid (1) is obtained in the same manner as in the preparation of Resin P1. A flow rate of the monomer mixed liquid is set to have the same rate of nitrogen gas, and the liquid is poured into an introductory part of the micro-reactor 2, which is produced as above and listed in Table 1, at a uniform inflow rate of 40 mL/min. A temperature control is carried out to constantly have the temperature of materials of 130° C. Nitrogen continuously is spilled in the flow channel of the micro-reactor for 2 hours to maintain a volume flow rate of nitrogen to have the same flow rate of the monomer mixed liquid (1). After that, reactants are recovered to obtain a uniformly transparent non-crystalline polyester resin. The reactants are removed from a desiccator under reduced pressure and the solvent is continuously removed for 10 hours. Here, small amount of a resin sample is collected to measure the following properties.

| | |
|---|---|
| Number-averaged molecular weight Mn | 7210 |
| Weight-averaged molecular weight Mw | 14950 |
| MWD | 2.07 |
| Glass transition temperature (onset) | 61° C. |
| L* of resin powder pellet | 97.16 |

A detection amount of a metal derived from a catalyst contained in the resin thus obtained is measured by using a fluorescent X-ray. As a result, the detection amount is 0 ppm which is a detection limit or below.

<Preparation of Resin P3>

The monomer mixed liquid (1) is obtained in the same manner as in the preparation of Resin P1. A flow rate of the monomer mixed liquid is set to have the same rate of nitrogen gas, and the liquid is poured into an introductory part of the micro-reactor 3, which is produced as above and listed in Table 1, at a uniform inflow rate of 40 mL/min. A temperature control is carried out to constantly have the temperature of materials of 130° C. Nitrogen continuously is spilled in the flow channel of the micro-reactor for 2 hours to maintain a volume flow rate of nitrogen to be 80 mL/min. After that, reactants are recovered to obtain a uniformly transparent non-crystalline polyester resin. The reactants are removed from a desiccator under reduced pressure and the solvent is continuously removed for 10 hours.

Here, small amount of a resin sample is collected to measure the following properties.

| | |
|---|---|
| Number-averaged molecular weight Mn | 6940 |
| Weight-averaged molecular weight Mw | 14010 |
| MWD | 2.02 |
| Glass transition temperature (onset) | 60° C. |
| L* of resin powder pellet | 97.29 |

A detection amount of a metal derived from a catalyst contained in the resin thus obtained is measured by using a fluorescent X-ray. As a result, the detection amount is 0 ppm which is a detection limit or below.

<Preparation of Resin P4>

| | |
|---|---|
| Propylene oxide 1 mol adduct of bisphenol A | 25.15 parts by weight |
| (2 mol adduct to both terminals) | |
| Bisphenoxy ethanol fluorene (2 mol adduct to | 7.89 parts by weight |
| both terminals) | |
| 1,4-phenylene diacetic acid | 14.97 parts by weight |
| Dodecylbenzene sulfonic acid | 0.03 parts by weight |
| Xylene | 20 parts by weight |

Above materials are mixed and introduced to a reactor equipped with a stirrer. The mixture is stirred for 10 minutes in a closed system to reach 120° C. of the resin temperature, thereby obtaining a monomer mixed liquid (4) in which the materials are uniformly mixed.

A flow rate of the monomer mixed liquid (4) is set to be 40 mL/min, and the liquid is poured into an introductory part of the micro-reactor 1, which is produced as above and listed in Table 1, at a uniform inflow rate. A temperature control is carried out to constantly have the temperature of materials of 130° C. Nitrogen continuously is spilled in the flow channel of the micro-reactor for 2 hours to maintain a volume flow rate of nitrogen to be 80 mL/min. After that, reactants are recovered to obtain a uniformly transparent non-crystalline polyester resin. The reactants are removed from a desiccator under reduced pressure and the solvent is continuously removed for 10 hours.

### Here, small amount of a resin sample is collected to measure the following properties.

| | |
|---|---|
| Number-averaged molecular weight Mn | 6140 |
| Weight-averaged molecular weight Mw | 13110 |
| MWD | 2.14 |
| Glass transition temperature (onset) | 62° C. |
| L* of resin powder pellet | 97.64 |

<Preparation of P5>

| | |
|---|---|
| Ethylene oxide 1 mol adduct of bisphenol A | 32.72 parts by weight |
| (2 mol adduct to both terminals) | |
| 1,4-cyclohexane dicarboxylic acid | 15.28 parts by weight |
| Dodecylbenzene sulfonic acid | 0.03 parts by weight |
| Xylene | 20 parts by weight |

Above materials are mixed and introduced to a reactor equipped with a stirrer. The mixture is stirred for 10 minutes in a closed system to have 120° C. of the resin temperature, thereby obtaining a monomer mixed liquid (5) in which the materials are uniformly mixed A flow rate of the monomer mixed liquid (5) is set to be 40 mL/min, and the liquid is poured into an introductory part of the micro-reactor 1, which is produced as above and listed in Table 1, at a uniform inflow rate. A temperature control is carried out to constantly have the temperature of materials of 130° C. Nitrogen continuously is spilled in the flow channel of the micro-reactor for 2 hours to maintain a volume flow rate of nitrogen to be 80 mL/min. After that, reactants are recovered to obtain a uniformly transparent non-crystalline polyester resin. The reactants are removed from a desiccator under reduced pressure and the solvent is continuously removed for 10 hours.

Here, small amount of resin sample is collected to measure the following properties.

| | |
|---|---|
| Number-averaged molecular weight Mn | 6640 |
| Weight-averaged molecular weight Mw | 14050 |
| MWD | 2.12 |
| Glass transition temperature (onset) | 64° C. |
| L* of resin powder pellet | 97.56 |

<Preparation of Resin P6=

| | |
|---|---|
| Ethylene oxide 1 mol adduct of bisphenol A | 23.85 parts by weight |
| (2 mol adduct to both terminals) | |
| Bisphenoxy ethanol fluorene (2 mol adduct | 8.14 parts by weight |
| to both terminals) | |
| 1,4-phenylene diacetic acid | 16.00 parts by weight |
| Dodecylbenzene sulfonic acid | 0.03 parts by weight |
| Xylene | 20 parts by weight |

Above materials are mixed and introduced to a reactor equipped with a stirrer. The mixture is stirred for 10 minutes in a closed system to reach 120° C. of the resin temperature, thereby obtaining a monomer mixed liquid (6) in which the material are uniformly mixed. A flow rate of the monomer mixed liquid (6) is set to be 40 mL/min, and the liquid is poured into an introductory part of the micro-reactor 1, which is produced as above and listed in Table 1, at a uniform inflow rate. A temperature control is carried out to constantly have the temperature of materials of 130° C. Nitrogen continuously is spilled in the flow channel of the micro-reactor for 2.5 hours to maintain a volume flow rate of nitrogen to be 80 mL/min.

After that, reactants are recovered to obtain a uniformly transparent non-crystalline polyester resin. The reactants are removed from a desiccator under reduced pressure and the solvent is continuously removed for 10 hours.

Here, small amount of a resin sample is collected to measure the following properties.

| | |
|---|---|
| Number-averaged molecular weight Mn | 6760 |
| Weight-averaged molecular weight Mw | 14500 |
| MWD | 2.15 |
| Glass transition temperature (onset) | 62° C. |
| L* of resin powder pellet | 97.6 |

<Preparation of Resin P7>

| | |
|---|---|
| Ethylene oxide 1 mol adduct of bisphenol A | 23.85 parts by weight |
| (2 mol adduct to both terminals) | |
| Bisphenoxy ethanol fluorene (2 mol adduct to | 8.14 parts by weight |
| both terminals) | |
| 1,4-cyclohexane dicarboxylic acid | 16.00 parts by weight |
| Dibutyltin oxide | 0.03 parts by weight |
| Xylene | 20 parts by weight |

Above materials are mixed and introduced to a reactor equipped with a stirrer. The mixture is stirred for 10 minutes in an closed system to reach 150° C. of the resin temperature, thereby obtaining a monomer mixed liquid (7) in which the materials are uniformly mixed. A flow rate of the monomer mixed liquid (7) is set to be 40 mL/min, and the liquid is poured into an introductory part of the micro-reactor 1, which is produced as above and listed in Table 1, at a uniform inflow rate. A temperature control is carried out to constantly have the temperature of materials of 150° C. Nitrogen continuously is spilled in the flow channel of the micro-reactor for 2.5 hours to maintain a volume flow rate of nitrogen to be 80 mL/min.

After that, reactants are recovered to obtain a uniformly transparent non-crystalline polyester resin. The reactants are removed from a desiccator under reduced pressure and the solvent is continuously removed for 10 hours.

Here, small amount of a resin sample is collected to measure the following properties.

| | | |
|---|---|---|
| Number-averaged molecular weight Mn | 3950 | |
| Weight-averaged molecular weight Mw | 8610 | |
| MWD | 2.18 | |
| Glass transition temperature (onset) | 60° | C. |
| L* of resin powder pellet | 95.9 | |
| Detection amount of metal derived from catalyst | 350 | ppm |

<Preparation of Resin P8>

| | |
|---|---|
| Ethylene oxide 1 mol adduct of bisphenol A | 23.85 parts by weight |
| (2 mol adduct to both terminals) | |
| Bisphenoxy ethanol fluorene (2 mol adduct | 8.14 parts by weight |
| to both terminals) | |
| 1,4-cyclohexane dicarboxylic acid | 16.00 parts by weight |
| Dodecylbenzene sulfonic acid | 0.03 parts by weight |
| Xylene | 20 parts by weight |

Above materials are mixed and introduced to a reactor equipped with a stirrer. The mixture is stirred for 10 minutes in a closed system to reach 130° C. of the resin temperature, thereby obtaining a monomer mixed liquid (8) in which the materials are uniformly mixed. A flow rate of the monomer mixed liquid is set to be 40 mL/min, and the liquid is poured into an introductory part of the micro-reactor 4, which is produced as above and listed in Table 1, at a uniform inflow rate. A temperature control is carried out to constantly have the temperature of materials of 120° C. Nitrogen continuously is spilled in the flow channel of the micro-reactor for 2.5 hours to maintain a volume flow rate of nitrogen to be 80 mL/min.

After that, reactants are recovered to obtain a uniformly transparent non-crystalline polyester resin. The reactants are removed from a desiccator under reduced pressure and the solvent is continuously removed for 10 hours.

Here, small amount of a resin sample is collected to measure the following properties.

| | | |
|---|---|---|
| Number-averaged molecular weight Mn | 6020 | |
| Weight-averaged molecular weight Mw | 12950 | |
| MWD | 2.15 | |
| Glass transition temperature (onset) | 60° | C. |
| L* of resin powder pellet | 97.12 | |
| Detection amount of metal derived from catalyst | 0 | ppm |

<Preparation of Resin P9>

| | |
|---|---|
| Ethylene oxide 1 mol adduct of bisphenol A | 23.85 parts by weight |
| (2 mol adduct to both terminals) | |
| Bisphenoxy ethanol fluorene (2 mol adduct | 8.14 parts by weight |
| to both terminals) | |
| 1,4-cyclohexane dicarboxylic acid | 16.00 parts by weight |
| Dodecylbenzene sulfonic acid | 0.03 parts by weight |
| Xylene | 20 parts by weight |

Above materials are mixed and introduced to a reactor equipped with a stirrer. The mixture is stirred for 10 minutes in a closed system to reach 130° C. of the resin temperature, thereby obtaining a monomer mixed liquid (9) in which the materials are uniformly mixed. A flow rate of the monomer mixed liquid is set to be 40 mL/min, and the liquid is poured into an introductory part of the micro-reactor 4, which is produced as above and listed in Table 1, at a uniform inflow rate. A temperature control is carried out to constantly have the temperature of materials of 120° C. Nitrogen continuously is spilled in the flow channel of the micro-reactor for 2.5 hours to maintain a volume flow rate of nitrogen to be 80 mL/min.

After that, reactants are recovered to obtain a uniformly transparent non-crystalline polyester resin. The reactants are removed from a desiccator under reduced pressure and the solvent is continuously removed for 10 hours.

Here, small amount of a resin sample is collected to measure the following properties.

| | |
|---|---|
| Number-averaged molecular weight Mn | 6230 |
| Weight-averaged molecular weight Mw | 13540 |
| MWD | 2.17 |
| Glass transition temperature (onset) | 61° C. |
| L* of resin powder pellet | 97.23 |
| Detection amount of metal derived from catalyst | 0 ppm |

<Preparation of Resin P10>

| | | |
|---|---|---|
| Ethylene oxide 1 mol adduct of bisphenol Z | 32.72 | parts by weight |
| (2 mol adduct to both terminals) | | |
| 1,4-cyclohexane dicarboxylic acid | 15.28 | parts by weight |
| Dodecylbenzene sulfonic acid | 0.03 | parts by weight |

Above materials are mixed and introduced to a reactor equipped with a stirrer. The mixture is stirred for 24 hours in an open system to reach 120° C. of the resin temperature.

After that, the reactants are recovered to obtain a transparent non-crystalline polyester resin colored with a light liver color.

### Here, small amount of a resin sample is collected to measure the following properties.

| | |
|---|---|
| Number-averaged molecular weight Mn | 1190 |
| Weight-averaged molecular weight Mw | 3740 |
| MWD | 3.14 |
| Glass transition temperature (onset) | 51° C. |
| L* of resin powder pellet | 78.22 |

As mentioned above, reaction is not progressed to such an extent, a molecular weight distribution is broad, and the resin has a slightly turbid color with light liver color.

<Preparation of Resin P11>

| | | |
|---|---|---|
| Propylene oxide 1 mol adduct of bisphenol A | 25.15 | parts by weight |
| (2 mol adduct to both terminals) | | |
| Bisphenoxy ethanol fluorene (2 mol adduct to | 7.89 | parts by weight |
| both terminals) | | |
| Phenylene diacetic acid | 14.97 | parts by weight |
| Dodecylbenzene sulfonic acid | 0.12 | parts by weight |

Above materials are mixed and introduced to a reactor equipped with a stirrer. The mixture is spilled for 24 hours in an open system to reach 120° C. of the resin temperature.

After that, the reactants are recovered to obtain a transparent non-crystalline polyester resin colored with a dark liver color.

Here, small amount of a resin sample is collected to measure the following properties.

| | |
|---|---|
| Number-averaged molecular weight Mn | 5140 |
| Weight-averaged molecular weight Mw | 16850 |
| MWD | 3.28 |
| Glass transition temperature (onset) | 61° C. |
| L* of resin powder pellet | 39.55 |

<Preparation of Resin P12>

| | | |
|---|---|---|
| Propylene oxide 1 mol adduct of bisphenol A | 25.15 | parts by weight |
| (2 mol adduct to both terminals) | | |
| Bisphenoxy ethanol fluorene (2 mol adduct to | 7.89 | parts by weight |
| both terminals) | | |
| Phenylene diacetic acid | 14.97 | parts by weight |
| Dibutyltin oxide <{CH₃(CH₂)₃}₂Sno> | 0.12 | parts by weight |
| Xylene | 20 | parts by weight |

Above materials are mixed and introduced to a reactor equipped with a stirrer. The mixture is stirred for 10 minutes in a closed system to have 120° C. of the resin temperature, thereby obtaining a monomer mixed liquid (2) in which the material are uniformly mixed. A flow rate of the monomer mixed liquid is set to have the same rate of nitrogen gas, and the liquid is poured into an introductory part of the micro-reactor 1 produced as above at a uniform inflow rate. A temperature control is carried out to constantly have the temperature of materials of 120° C. Nitrogen continuously is spilled in the flow channel of the micro-reactor for 2 hours to maintain a volume flow rate of nitrogen to have the same flow rate of the monomer mixed liquid (2) (40 mL/min). The reactants are removed from a desiccator under reduced pressure and the solvent is continuously removed for 10 hours.

After that, the reactants are recovered and it is found that a polymerization mostly is not progressed.

| | |
|---|---|
| Number-averaged molecular weight Mn | 840 |
| Weight-averaged molecular weight Mw | 1980 |
| MWD | 2.36 |
| Glass transition temperature (onset) | room temperature |
| | or below (liquid phase) |
| L* of resin powder pellet | unmeasurable because |
| | of liquid phase |
| Detection amount of metal derived from catalyst | 3220 ppm |

<Preparation of Resin P13>

| | | |
|---|---|---|
| Ethylene oxide 1 mol adduct of bisphenol A | 23.85 | parts by weight |
| (2 mol adduct to both terminals) | | |
| Bisphenoxy ethanol fluorene (2 mol adduct to | 8.14 | parts by weight |
| both terminals) | | |
| 1,4-cyclohexane dicarboxylic acid | 16.00 | parts by weight |
| Dodecylbenzene sulfonic acid | 0.03 | parts by weight |
| Xylene | 20 | parts by weight |

Above materials are mixed and introduced to a reactor equipped with a stirrer. The mixture is stirred for 10 minutes in an closed system to have 120° C. of the resin temperature, thereby obtaining a monomer mixed liquid (1) in which the materials are uniformly mixed. A flow rate of the monomer mixed liquid is set to be 40 mL/min, and the liquid is poured into an introductory part of the micro-reactor 1 produced as above at a uniform inflow rate. A temperature control is carried out to constantly have the temperature of materials of 130° C., and the liquid is continuously spilled in the flow channel of the micro-reactor for 2 hours. After that, reactants are recovered to obtain a uniformly transparent non-crystalline polyester resin. The reactants are removed from a desiccator under reduced pressure and the solvent is continuously removed for 10 hours.

### Here, small amount of a resin sample is collected to measure the following properties.

| | |
|---|---|
| Number-averaged molecular weight Mn | 1090 |
| Weight-averaged molecular weight Mw | 3550 |
| MWD | 3.26 |
| Glass transition temperature (onset) | 41° C. |
| L* of resin powder pellet | 97.25 |

<Preparation of Resin P14>

| | | |
|---|---|---|
| Propylene oxide 1 mol adduct of bisphenol A | 25.15 | parts by weight |
| (2 mol adduct to both terminals) | | |
| Bisphenoxy ethanol fluorene (2 mol adduct to | 7.89 | parts by weight |
| both terminals) | | |
| Phenylene diacetic acid | 14.97 | parts by weight |
| Dibutyltin oxide <{CH₃(CH₂)₃}₂SnO> | 0.12 | parts by weight |

Above materials are mixed and introduced to a reactor equipped with a stirrer. The pressure in the reactor is reduced to 0.4 Mpa and a polymerization is carried out in the reactor for 40 hours to reach 120° C. of the resin temperature.

### After that, the reactants are recovered to obtain a transparent non-crystalline polyester resin colored with a light liver color.

### Here, small amount of a resin sample is collected to measure the following properties.

| | |
|---|---|
| Number-averaged molecular weight Mn | 5430 |
| Weight-averaged molecular weight Mw | 16910 |
| MWD | 3.11 |
| Glass transition temperature (onset) | 62° C. |
| L* of resin powder pellet | 80.66 |
| Detection amount of metal derived from catalyst | 3570 ppm |

The results thus obtained are shown in the following table.

TABLE 2

| | | Resin Examples | | | | | | |
|---|---|---|---|---|---|---|---|---|
| | | 1 | 2 | 3 | 4 | 5 | 6 | 7 |
| | Resin | P1 | P2 | P3 | P4 | P5 | P6 | P7 |
| Monomer, | Polyol 1 | BPA- | BPA- | BPA- | BPA- | BPZ- | BPA- | BPA- |
| Material | | 1EO | 1EO | 1EO | 1PO | 1EO | 1EO | 1EO |
| | Polyol 2 | BPEF | BPEF | BPEF | BPEF | — | BPEF | BPEF |
| | Polycarboxylic | CHDA | CHDA | CHDA | PDAA | CHDA | PDAA | CHDA |
| | acid | | | | | | | |
| | Catalyst | DBSA | DBSA | DBSA | DBSA | DBSA | DBSA | SnBuO |
| | (concentration) | (0.05 mol %) | (0.05 mol %) | (0.05 mol %) | (0.05 mol %) | (0.05 mol %) | (0.05 mol %) | (0.06 mol %) |
| | Solvent | Xylene | Xylene | Xylene | Xylene | Xylene | Xylene | Xylene |
| Monomer mixing | | 120 | 120 | 120 | 120 | 120 | 120 | 150 |
| temperature (° C.) | | | | | | | | |
| MR | Reacting device | MR1 | MR2 | MR3 | MR1 | MR1 | MR1 | MR1 |
| | Monomer flow | 40 | 40 | 40 | 40 | 40 | 40 | 40 |
| | rate (mL/min) | | | | | | | |
| | N₂ flow rate | 40 | 40 | 40 | 80 | 80 | 80 | 80 |
| | (mL/min) | | | | | | | |
| | Polymerization | 120° C./ | 120° C./ | 120° C./ | 120° C./ | 120° C./ | 120° C./ | 120° C./ |
| | temp./Time | 2 h | 2 h | 2 h | 2 h | 2 h | 2 h | 2 h |
| Resin | Mn | 5980 | 7210 | 6940 | 6140 | 6640 | 6760 | 3950 |
| property | Mw | 12660 | 14950 | 14010 | 13110 | 14050 | 14500 | 8610 |
| | Mwd | 2.12 | 2.07 | 2.02 | 2.14 | 2.12 | 2.14 | 2.18 |
| | Tg (2nd) | 60 | 61 | 60 | 62 | 64 | 62 | 60 |
| | Resin pellet | 97.22 | 97.16 | 97.29 | 97.64 | 97.56 | 97.6 | 95.9 |
| | coloring (L*) | | | | | | | |
| | Detection | 0 | 0 | 0 | 0 | 0 | 0 | 350 |
| | amount of metal | | | | | | | |
| | derived from | | | | | | | |
| | catalyst (ppm) | | | | | | | |
| | | Resin Examples | | Resin Comparative Examples | | | | |
| | | 8 | 9 | 1 | 2 | 3 | 4 | 5 |
| | Resin | P8 | P9 | P10 | P11 | P12 | P13 | P14 |
| Monomer, | Polyol 1 | BPA- | BPA- | BPZ-1EO | BPA-1PO | BPA- | BPA- | BPA-1PO |
| Material | | 1EO | 1EO | | | 1PO | 1EO | |
| | Polyol 2 | BPEF | BPEF | — | BPEF | BPEF | BPEF | BPEF |
| | Polycarboxylic | CHDA | CHDA | CHDA | PDAA | PDAA | CHDA | PDAA |
| | acid | | | | | | | |
| | Catalyst | DBSA | DBSA | DBSA | DBSA | SnBuO | DBSA | SnBuO |
| | (concentration) | (0.05 mol %) | (0.05 mol %) | (0.05 mol %) | (0.2 mol %) | (0.26 mol %) | (0.05 mol %) | (0.26 mol %) |
| | Solvent | Xylene | Xylene | — | — | Xylene | Xylene | — |
| Monomer mixing | | 120 | 120 | | | | | |
| temperature (° C.) | | | | | | | | |
| MR | Reacting device | MR4 | MR5 | BR | BR | MR1 | MR2 | BR |
| | Monomer flow | 40 | 40 | — | — | 40 | — | — |
| | rate (mL/min) | | | | | | | |
| | N₂ flow rate | 80 | 80 | Normal | Normal | 40 | 40 | High |
| | (mL/min) | | | pressure | pressure | | | temp. and |
| | | | | open | open | | | reduced |
| | | | | system | system | | | pressure |
| | Polymerization | 120° C./ | 120° C./ | 120° C./ | 120° C./ | 120° C./ | 120° C./ | 120° C./ |
| | temp./Time | 2 h | 2 h | 24 h | 24 h | 2 h | 2 h | 40 h |
| Resin | Mn | 6020 | 6230 | 1190 | 5140 | 840 | 1090 | 5430 |
| property | Mw | 12950 | 13540 | 3740 | 16850 | 1980 | 3550 | 16910 |
| | Mwd | 2.15 | 2.17 | 3.14 | 3.28 | 2.36 | 3.26 | 3.11 |
| | Tg (2nd) | 60 | 61 | 51 | 61 | — | 41 | 62 |
| | Resin pellet | 97.12 | 97.23 | 78.22 | 39.55 | — | 97.25 | 80.66 |
| | coloring (L*) | | | | | | | |
| | Detection | 0 | 0 | 0 | 0 | 3220 | 0 | 3570 |
| | amount of metal | | | | | | | |
| | derived from | | | | | | | |
| | catalyst (ppm) | | | | | | | |

BPA-1EO: Ethylene oxide 1 mol adduct of bisphenol A (2 mol adduct to both terminals)
BPZ-1EO: Ethylene oxide 1 mol adduct of bisphenol Z (2 mol adduct to both terminals)
BPA-1EO: Propylene oxide 1 mol adduct of bisphenol A (2 mol adduct to both terminals)
BPEF: Bisphenoxy ethanol carboxylic acid
CHDA: 1,4-cyclohexane dicarboxylic acid
PDAA: 1,4-phenylene diacetic acid
DBSA: Dodecylbenzene sulfonic acid
SnBnO: Dibutyltin oxide
MR: Micro-reactor
BR: Batch-reactor

<Preparation of Resin Particle Dispersion Liquid L1>

15 parts by mass of resin P1 obtained as mentioned above is introduced to the same reactor equipped with a stirrer. 0.2 parts by mass of dodecylbenzene sodium sulfonate as a surfactant and 30 parts by mass of 0.2 mol/L sodium hydroxide aqueous solution heated to 90° C. are added to the reactor and stirred for 2 hours at 90° C. After that, 10 parts by mass of ion-exchange water heated to 80° C. is added to the reactor and then sufficiently mixed and stirred by the use of a homogenizer (Ultra-Turrax T50 manufactured by IKA Co., Ltd.), thereby dispersing the resin into the water.

According to the above-mentioned method, a non-crystalline polyester resin particle dispersion liquid L1 having a particle core diameter of 210 mm is obtained. In addition, the particle diameter of the resin particle dispersion liquid thus obtained is measured by a laser diffraction type particle size distribution-measuring device (LA-920 manufactured by Horiba Ltd.).

<Preparation of Resin Particle Dispersion Liquids L2 to L9>

Resin particle dispersion liquids L2 to L9 are prepared in the same manner as in the preparation of the resin particle dispersion liquid L1. The core diameters of the resin particles in the resin and in the resin particle dispersion liquid used in the invention are shown in Table 3.

In addition, since the polymerization of the resin P12 and P13 are not mostly progressed, preparation of the resin dispersion liquid is not carried out.

For preparing a toner by using the resin dispersion liquid thus prepared as a basic material, the releasing agent particle dispersion liquid W1 and the colorant dispersion liquid described below are prepared.

### <Preparation of Releasing Agent Particle Dispersion Liquid W1>

| | |
|---|---|
| Polyethylene wax (Polywax725 manufactured by | 30 parts by mass |
| Toyo-Petrolite, melting point 130° C.) | |
| Cationic surfactant (SanizoleB50 manufactured by | 3 parts by mass |
| Kao Corporation) | |
| Ion-exchange water | 67 parts by mass |

Above components are heated to 95° C. and sufficiently dispersed by the use of a homogenizer (Ultra-Turrax T50 manufactured by IKA Co., Ltd.). Then, the mixture is subjected to a dispersion treatment by the use of a pressurized extrusion-type homogenizer (Gaulin homogenizer manufactured by Gaulin Corporation) to prepare a releasing agent particle dispersion liquid (W1). A number average particle diameter D50n of the releasing agent fine particles in the dispersion liquid thus obtained is 4600 nm. After that, ion-exchange water is added to adjust the solid powder concentration of the dispersion liquid to 30%.

<Preparation of Cyan Pigment Dispersion Liquid C1>

| | |
|---|---|
| Cyan Pigment (PB 15:3 manufactured by | 20 parts by mass |
| Dainichiseika Color & Chemicals mfg. Co., Ltd.) | |
| Anion surfactant (Neogen R manufactured by Daiichi | 2 parts by mass |
| Kogyo Seiyaku Co., Ltd.) | |
| Ion-exchange water | 78 parts by mass |

Above components are used for preparation in the same manner as in the preparation of the magenta pigment dispersion liquid (M1) to obtain a cyan pigment dispersion liquid. A number average particle diameter D50n of the pigment in the dispersion liquid is 121 nm. After that, ion-exchange water is added to adjust the solid powder concentration of the dispersion liquid to 15%.

<Preparation of Yellow Colorant Particle Dispersion Liquid Y1 for Fixing Secondary Color and Measuring L*>

| | |
|---|---|
| Yellow pigment (C.I. Pigment Yellow 74 | 20 parts by mass |
| manufactured by Clariant Japan K.K) | |
| Anion surfactant (Neogen R manufactured by Daiichi | 2 parts by mass |
| Kogyo Seiyaku Co., Ltd.) | |
| Ion-exchange water | 78 parts by mass |

Above components are used for preparation in the same manner as in the preparation of the colorant particle dispersion liquid (C1) to obtain a colorant particle dispersion liquid Y1. A number average particle diameter D50n of the pigment in the dispersion liquid is 118 nm. After that, ion-exchange water is added to adjust the solid powder concentration of the dispersion liquid to 15%.

### TONER EXAMPLE

<Preparation of Toner Particle>

### Toner Example 1

| | |
|---|---|
| Resin fine particle dispersion liquid (1) | 160 parts by mass |
| Releasing agent fine particle dispersion liquid | 33 parts by mass |
| (W1) | |
| Cyan pigment dispersion liquid (C1) | 60 parts by mass |
| 10% by mass aqueous solution of polyaluminum | 15 parts by mass |
| chloride (PAC100W manufactured by Asada | |
| Chemical Industry Co., Ltd.) | |
| 1% nitric acid aqueous solution | |

Above components are dispersed in a ring-shaped stainless steel flask for 3 minutes under 5000 rμm by the use of a homogenizer (Ultra-Turrax T50 manufactured by IKA Co., Ltd.). After that, the flask is covered with a lid equipped with a stirring device having magnetic seal, a thermometer, and a pH meter, and a mantle heater for heating is set. The dispersion liquid in the flask is stirred by a minimum rotational frequency which is suitably regulated to stir the whole dispersion liquid and heated up to 62° C. at a rate of 1° C./min. The dispersion liquid is maintained at 62° C. for 30 minutes and a particle diameter of an aggregated particle is confirmed by using a Coulter counter (TAII manufactured by Nikkaki).

After the increase in temperature is completed, 50 parts by mass of the resin fine particle dispersion liquid (L1) is immediately added the flask, and maintained for 30 minutes. Sodium hydroxide aqueous solution is added to the flask till the pH value in the system becomes 6.5 and the flask is heated up to 97° C. at a rate of 1° C./1 min. After the temperature is increased, nitric acid aqueous solution is added to the flask to have the pH value in the system of 5.0 and maintained for 10 hours, thereby heating and blending the aggregated particle.

After that, inside of the system is heated up to 50° C., sodium hydroxide aqueous solution is added the flask to regulate the pH value in the system of 12.0, and maintained for 10 minutes. Then, the aggregated particle is collected from the flask, sufficiently filtered by using ion-exchange water, and washed through water. The particles are again dispersed in the ion-exchange water to have a solid powder amount of 10% by weight, nitric acid is added to the mixture to have the pH value of 3.0, and the mixture is stirred for 10 minutes. After that, the mixture is sufficiently filtered by using ion-exchange water, and washed through water. Slurry thus obtained is lyophilized to obtain a cyan toner (toner C1).

To the cyan colorant particles, 1% by weight of a silica (SiO₂) fine particle having an average primary particle size of 40 nm of which surface is hydrophobizing treated by hexamethyl disilazane (hereinafter, may be referred as an abbreviation as ‘HMDS’) and methatitanate compound fine particle having an average primary particle size of 20 nm which is a product obtained by reacting methatitanate and isobutyl trimethoxysilane is respectively added, and mixed with a Henschel mixer, thereby preparing a cyan external additive toner.

Particle diameters of the toner particles prepared by the process are measured with the Coulter Counter. As a result, an accumulative volume average particle size D₅₀ is 4.96 μm and a volume average particle size distribution index GSDv is 1.20. A shape factor SF1 of the toner particle obtained from an observation of the shape by using LUZEX is 135 and the toner particle has a potato shape.

### Toner Examples 2 to 9

A cyan colorant particle is obtained in the same manner as in Toner Example 1 except that the resin dispersion liquid 2 is changed with the resin dispersion liquid 3. An accumulative volume average particle size D₅₀, a volume average particle size distribution index GSDv, a shape factor are measured. To this toner, an external additive is externally added same as in Toner Example 1, thereby obtaining a cyan external additive toner. The results are shown in Table 3.

### TONER COMPARATIVE EXAMPLE

### Toner Comparative Examples 1 to 3

A cyan colorant particle is obtained in the same manner as in Toner Example 1 except that the resin dispersion liquid L10 is changed with the resin dispersion liquid L12. An accumulative volume average particle size D₅₀, a volume average particle size distribution index GSDv, a shape factor are measured. To this toner, an external additive is externally added same as in Toner Example 1, thereby obtaining a cyan external additive toner. The results are shown in Table 3.

<Production of Carrier>

To 100 parts by weight of Cu—Zn ferrite fine particle having the volume average particle size of 40 μm a methanol solution containing 0.1 parts by weight of γ-aminoprophyltriethoxysilane is added. The particle is coated with the methanol solution by using a kneader and then methanol is distilled away. The particle is heated at 120° C. for 2 hours to completely harden the silane compound. To the particle, a solution in which a copolymer of perfluorooctylethyl methacrylate-methylmethacrylate (copolymerization ratio of 40:60) is dissolved in toluene is added, and a resin coated carrier is produced by the use of a vacuum depressurized kneader to have a coating amount of the copolymer of perfluorooctylethyl methacrylate-methylmethacrylate of 0.5% by weight.

<Production of Developer>

8 parts by weight of the toners thus prepared are introduced to 100 parts by weight of the resin coated carrier thus obtained, the mixture is mixed by using a V blender, thereby producing an electrostatic charge image developer.

These developers are used in the evaluation described below.

By using the developers produced as above, evaluation of the toner and the image quality described below is carried out (evaluation of the toner and the image quality).

<Evaluation of Toner Particle and Image Quality>

[Evaluation of Fixing]

Evaluation of fixing and an image quality according to the developers obtained by the above-mentioned method is carried out by the use of a Docu Centre Color 500CP modified machine manufactured by Fuji Xerox Co., Ltd. The fixing evaluation described below is carried out under conditions of 140° C. of temperature and 240 mm/sec of process speed. For evaluation of the developer for storing it in a high humidity environment, the modified device is stored in an environment of 35° C. of temperature and 65% of RH for one week and then the evaluation is carried out.

(1): Evaluation of Gloss Unevenness in Secondary Color (ΔGloss)

A yellow toner for fixing a secondary color is prepared by changing the colorant particle dispersion liquid C1 with Y1 by the use of the resin particle dispersion liquids L1 to L11 in the same manner as in the preparation of the cyan toner in Examples 1 to 9 and Comparative Examples 1 to 3.

On a thin film (P paper manufactured by FX (A4 size), a non-fixed solid image which has green color made of the cyan toner and the secondary color of the yellow toner thus obtained and size of 5×50 cm is formed. For evaluation of fixing, 10 sheets of the P paper (A4 size) on which nothing is fixed are continuously passed through the modified machine and then the non-fixed image is passed through the modified machine to fix the image. The image is left for a few hours and then glosses of the center part and 5 points including the vicinity of the center part in the solid image-forming unit are measured. The results are decided as follows according to the difference (ΔGloss) between the maximum gloss value and the minimum gloss value among the measured value of the 5 points
A: ΔGloss=(maximum gloss value)−(minimum gloss value)≦4
B: 4<ΔGloss<5
C: 5≦ΔGloss

Each toner thus obtained is evaluated as above, and the results are as follows.

When a solid image on which secondary color of the toners prepared according to the methods described in Examples 1 to 9 is fixed is prepared and gloss of 5 points thereof is measured, ΔGloss is 4 or below as shown in Table and gloss unevenness is not confirmed with eyes. On the other hand, the results according to the toner in Comparative Examples 1 to 3 are as follows.

In Comparative Example 1, a value of ΔGloss is 5.2 and gloss unevenness is confirmed with eyes.

In Comparative Example 2, a value of ΔGloss is 4.1 and slight gloss unevenness which can be confirmed by staring with eyes is confirmed.

In Comparative Example 3, a value of ΔGloss is 4.1 and slight gloss unevenness which can be confirmed by staring with eyes is confirmed.

(2): Evaluation of ΔID (AC5% difference in image density) Image Quality of Cyan Low Area Coverage Image before/after Stored in High-Humidity

For the toners prepared in Examples and Comparative Examples, a value of L* is measured by printing one sheet of a cyan image in a 5% of area coverage (A4 size) under the room temperature by the use of the Docu Centre Color 500 CP modified machine.

Criteria is as follows:

A: L*≧92.0

B: 91.5<L*<92.0

C: L*≦91.5

Each toner thus obtained is evaluated as above, and the results are as follows. According to the toners in Examples 1 to 9, the values of L* of the toners are 92.0 or higher thus an image having high luminosity is obtained even for a low AC image. On the other hand, according to the toners in Comparative Examples 1 and 2, the values of L* are 89.9 and 89.5 thus it is possible to confirm the image is darkened as compared to the fixed images in Example.

The toner in Comparative Example 3 has the value of L* of 91.64 and thus it is possible to confirm the image is slightly darkened as compared to the fixed images in Example.

In addition, the toner in Comparative Example 2 has the value of L* of 90 or below and it is possible to confirm the luminosity of the image is darkened with eyes.

(3): Evaluation of Image Quality of Fog in Non Image Part before/after being Stored in High-Humidity

The developers thus prepared are stored under the conditions of high-temperature and high-humidity for 1 week, 50000 sheets of thin lined image are printed out by the use of the modified machine. After that, a non-image part between the thin lines of the image fixed in the 50001st sheet is measured by a reflection densitometer (X-Rite404 manufactured by X-Rite Co., Ltd.). When there is an increase in reflection density by over 0.01 at a position where a surface fog is appeared, it is represented as B, and when there is an increase in reflection density by 0.01 or less, it is represented as A.

Each toner thus obtained is evaluated as above, and the results are as follows. When the toners in Examples 1 to 9 and Comparative Example 1 are used, the fog is not completely appeared and the non-image part density measured by X-Rite404 is 0.01 or less.

### On the other hand, when the toners in Comparative Examples 2 and 3 are used, the increases in both non image part densities measured by X-Rite404 are confirmed to be 0.01 or higher and it is confirmed that slight fog is generated with eyes.

The results are shown in Table 3 below.

TABLE 3

| | | | | | | | Evaluation of Developer | | |
|---|---|---|---|---|---|---|---|---|---|
| | | | | | | | | | Fog in |
| | | | | | | | | | 50001st |
| | | Resin | | | | | | | cyan-non |
| | | Particle | | | | | Gloss | Value | image |
| | | Dispersion | | | | | unevenness | of L of | part |
| | | Liquid | | Toner | | | in | cyan- | stored |
| | | | D50v | | D50 | | secondary | AC5% | in high- |
| | Resin | No. | (nm) | No. | (μm) | GSDv | color | image | humidity |
| Examples | P1 | L1 | 210 | T1 | 4.96 | 1.20 | A | A | A |
| | P2 | L2 | 230 | T2 | 4.61 | 1.20 | A | A | A |
| | P3 | L3 | 210 | T3 | 4.58 | 1.20 | A | A | A |
| | P4 | L4 | 200 | T4 | 4.96 | 1.20 | A | A | A |
| | P5 | L5 | 230 | T5 | 4.45 | 1.20 | A | A | A |
| | P6 | L6 | 220 | T6 | 4.72 | 1.20 | A | A | A |
| | P7 | L7 | 220 | T7 | 4.82 | 1.20 | A | A | A |
| | P8 | L8 | 220 | T8 | 4.91 | 1.20 | A | A | A |
| | P9 | L9 | 220 | T9 | 4.87 | 1.20 | A | A | A |
| Comparative | P10 | L10 | 260 | T10 | 6.75 | 1.31 | C | C | A |
| Examples | P11 | L11 | 240 | T11 | 4.65 | 1.20 | B | C | B |
| | P14 | L12 | 170 | T12 | 6.67 | 1.34 | B | B | B |

What is claimed is:

1. A polyester resin having:
a molecular weight distribution (MWD) of approximately from 1.0 to 2.2, wherein the molecular weight distribution (MWD) is a weight-averaged molecular weight (Mw)/a number-averaged molecular weight (Mn); and
a luminosity (L*) of from approximately 97.0 to 100 when the polyester resin is molded in a diameter of 5 cm and a thickness of 2 mm.

2. The polyester resin according to claim 1,
wherein a polycarboxylic-acid-derived unit of the polyester resin comprises at least one of a structure represented by formula (1) and a structure represented by formula (2) in the range of approximately 50 mol % to 100 mol %; and
a polyalcohol-derived unit of the polyester resin comprises a structure represented by formula (3) in the range of approximately 50 mol % to 100 mol %:
-A¹ₘB¹ₙA¹ₗ- (1)
wherein A¹: methylene group, B¹: unsubstituted aromatic hydrocarbon group or substituted aromatic hydrocarbon group, 1≦m+1≦12, and 1≦n≦3;
-A²ₚB²_{q}A²_{z}- (2)
wherein A²: methylene group, B²: unsubstituted alicyclic hydrocarbon group or substituted alicyclic hydrocarbon group, 0≦p≦6, 0≦r≦6, and 1≦q≦3; and
—XₕYⱼXₖ— (3)
wherein X: alkylene oxide group, Y: bisphenol unit group, 1≦h+k≦10, and 1≦j≦3.

3. The polyester resin according to claim 1 further comprising a Brønsted acid that comprises a sulfur.

4. The polyester resin according to claim 1 further comprising a metal of approximately 100 ppm or less.

5. An electrostatic-image-developing toner comprising the polyester resin according to claim 1.

6. A developing apparatus comprising:
an image carrier;
a developer-supplying unit that supplies a developer comprising the electrostatic-image-developing toner according to claim 5 onto the image carrier; and
a charging unit that charges the developer supplied by the developer-supplying unit.

7. A cartridge comprising:
an image carrier;
a developing unit that forms a toner image by developing an electrostatic latent image formed on a surface of the image carrier by using a developer comprising the electrostatic-image-developing toner according to claim 5; and
at least one of a charging unit that charges a surface of the image carrier and a cleaning unit that removes the developer remaining on the surface of the image carrier.

8. An image-forming apparatus comprising:
an image carrier;
a charging unit that charges a surface of the image carrier;
a latent-image-forming unit that forms a latent image on the surface of the image carrier;
a developer unit that forms a toner image by developing the latent image by using a developer comprising the electrostatic-image-developing toner according to claim 5;
a transfer unit that transfers the toner image to a recording medium; and
a fixing unit that fixes the toner image on the recording medium.

9. A production method of a polyester resin, comprising:
introducing liquid and gas into a micro-flow channel, the liquid comprising a monomer of a polyester;
forming a laminar flow of the liquid and the gas; and
polycondensing the monomer of the polyester resin in the laminar flow.

10. The production method of the polyester resin according to claim 9,
wherein the polycondensation is conducted at approximately from 70° C. to 150° C.

11. A micro-reactor apparatus comprising:
a micro-reactor main body;
a micro-flow channel comprising a liquid flow channel and a gas flow channel;
a circulating unit that supplying the liquid discharged from the micro-flow channel to the micro-flow channel again; and
a heating unit that heats the micro-flow channel.

12. The micro-reactor apparatus according to claim 11,
wherein a diameter of the liquid flow channel D1, a diameter of the gas flow channel D2, and a diameter of the micro-flow channel D3 satisfy the equations (i) and (ii) and the diameter of the gas flow channel D2 is in the range of approximately 1 μm to 5000 μm:
1≦D2/D1≦10 (i); and
0.5≦D3/(D1+D2)<1 (ii).

13. The micro-reactor apparatus according to claim 11,
wherein the micro-reactor flow channel has a length of approximately 0.3 m or more.
